(19) United States
(12) Patent Application Publication
(10) Pub. No.: US 2008/0206724 A1
(43) Pub. Date: Aug. 28, 2008

(54) Vowel based method of teaching the reading of English

(76) Inventor: Jane S. Volden, Bettendorf, IA (US)

Correspondence Address: LAW OFFICE OF JAY R. HAMILTON, PLC., 331 W. 3RD ST., NEW VENTURES CENTER SUITE 120, DAVENPORT, IA, 52801, US

(21) Appl. No.: 11/807,574

(22) Filed: May 29, 2007

Related U.S. Application Data
(60) Provisional application No. 60/903,911, filed on Feb. 28, 2007.

(51) Int. Cl. G09B 17/00

(52) U.S. Cl. 434/178

(57) ABSTRACT

The Voweletics teaching method is designed to create a THINK System simulating the mental process readers go through in determining the correct vowel phonemes to use when decoding words. Before beginning to read the word, Voweletics teaches the reader to first LOOK at the vowels in the word. Next, the reader will THINK which vowel phoneme will be heard according to the methods taught throughout the program. Once the vowel phoneme is determined, the reader proceeds to READ the word with the correct vowel phoneme inserted. The LOOK! THINK! READ! approach is a teaching method. This THINK System is applied until the reader has automatic recall of the vowel patterns taught in Voweletics. Voweletics takes 18 varied vowel sounds and classifies them into three types of vowels: short, long & special. Many of the program's components are color-coded using the colors shown above for the program's three vowel classifications.

### CROSS REFERENCE TO RELATED APPLICATIONS

Applicant claims priority under 35 U.S.C. §119 (e) of provisional U.S. Patent Application Ser. No. 60,903,911 filed on Feb. 28, 2007 which is also incorporated by reference herein.

### FIELD OF THE INVENTION

The apparatus and methods described herein are generally applicable to the field of education particularly as related to the teaching of reading to children and or teaching the English language to foreign language speakers desiring to learn English as a second language.

### STATEMENT REGARDING FEDERALLY SPONSORED RESEARCH OR DEVELOPMENT

No federal funds were used to develop or create the invention disclosed and described in the patent application.

### REFERENCE TO SEQUENCE LISTING, A TABLE, OR A COMPUTER PROGRAM LISTING COMPACT DISK APPENDIX

Not Applicable.

### AUTHORIZATION PURSUANT TO 37 C.F.R. §1.171 (d)(c)

A portion of the disclosure of this patent document contains material which is subject to copyright and trademark protection. The copyright owner has no objection to the facsimile reproduction by anyone of the patent document or the patent disclosure, as it appears in the Patent and Trademark Office patent file or records, but otherwise reserves all copyrights whatsoever.

### BACKGROUND OF THE INVENTION

1. Field of the Invention

This invention relates to a method and apparatus for teaching students to read English based on the vowel(s) found within the word, the relationship of the vowel(s) to the consonant(s) in the word and the rules to be applied to the word to decode the correct sound for the word.

2. Discussion

Learning to read the English language is considered a very difficult challenge, whether for children, illiterate adults or “English as a Second Language” (ESL) students. This is due primarily to the complexity of the written English language attributable to the language's roots in several other tongues. The English alphabet only has twenty-six letters, however the English language contains more than twenty-six phonemes. As a result of this discrepancy, many letters or strings of letters represent one or more phonemes dependent upon usage. This gives rise to great difficulty in the phonetic decoding of individual words. Unlike Spanish and other more truly phonetic languages, English words are often not spelled as they sound. From the point of view of one learning the language, for example, standard letter string representations of actual human-pronounceable sounds (phonemes) are misleading. See U.S. patent application Ser. No. 10,955,101 filed by Woodward and entitled “Phoneme decoding system and method”

U.S. Pat. No. 5,328,373 issued to R. Wood for a “Method and apparatus for teaching reading” discloses and claims an aid for teaching students to read, comprising sound letters formed from a standard English alphabet letters, each sound letter corresponding to a single sound most commonly associated with a particular alphabetic letter or combination of alphabetic letters of said standard alphabet, each said sound letter characterized as having a front, a back, a top, a bottom, a left side and a right side, said sound letters adapted for arrangement in a visually associated, juxtaposed relationship to form combinations of said sound letters so that students are able to read said combinations of said sound letters phonetically. Wood provides an excellent historical and factual background related to issues and problems related to the departure from phonetic based reading methods, as referenced and incorporated below. According to Wood, it is well known that the level of American educational performance has declined during the last thirty years. Over one hundred million scores on academic, college, and military entrance tests taken since the College Board started giving Scholastic Aptitude Tests (SAT's) in 1926 and the United States Department of Defense started giving Army General Classification Tests (AGCT's) in 1940 prove, however, that the level of American educational performance has been sinking for sixty years—almost twice as long as most people think.

Before 1929-30, virtually all normal American children learned to read during their first year in school. In common parlance, students learned “phonics”. Teachers taught children to read by matching sounds used to form spoken words to letters most often used to spell the sounds. Students learned to write words they heard by substituting letters for sounds and to read words they saw by substituting sounds for letters—even in words students had never seen before. Even dyslexic students and students with poor sight memories learned to read using phonics.

“See and say” reading instruction (also referred to by educators as whole word recognition or sight repetition of whole words) was introduced in the late Twenties. Students learned to read by seeing words printed and reprinted, flashed and re-flashed over and over again. Technicians with instruments for tracking eye movements delivered additional support for whole word recognition proponents. Laboratory records showed that fast-reading adults gobble whole words, whole phrases, sentences, and even whole paragraphs at a glance. Fast adult readers did not pause for “sounding out” letters or syllables. Whole words, the technicians said, are the smallest units good readers recognize.

Educational decision makers of the late Twenties were convinced. Sight repetition of whole words would produce better, faster readers. Further, sight repetition was easier and more fun than phonics, so the students would enjoy learning.

Many big city school districts dropped phonics instruction in the late Twenties and early Thirties and adopted the radically new see and say teaching method. After the introduction of see and say instruction, SAT verbal scores and fourth-grade illiteracy among armed forces recruits (inability to read fourth-grade lessons, the armed forces' line of demarcation between literate recruits and illiterate recruits) declined simultaneously. Between 1941 and 1952, the SAT verbal score average fell twenty-four points—from 500 to 476. Between 1940 and 1953, fourth-grade illiteracy among twenty million armed forces registrants with at least four years of schooling jumped from a negligible 0.4 percent in the World War II draft (1940 to 1945) to seventeen percent in the Korean War draft (1950 to 1953). During the Vietnam War draft (1965 to 1973), fourth-grade illiteracy among armed forces registrants attending at least four years of school jumped to twenty-five percent.

Among World War II recruits having at least four years of schooling, almost all recruits received phonics instruction and almost all were literate. Among Korean War recruits having at least four years of schooling, from one-third to one-half of the recruits received see and say instruction and seventeen percent were rejected as fourth-grade illiterates. Among Vietnam War recruits having at least four years of schooling, over ninety percent received see and say instruction, and about twenty-five percent could not read at the 1940's fourth-grade proficiency level.

During the period from 1964 to 1973, the average SAT verbal score fell over thirty points to 445. Since 1973, the average SAT verbal score dropped to a 1980 low of 424, rose to a post-1962 high of 431 in 1985, then sank to an all-time low of 422 in 1991. The average SAT verbal score in 1992 was a near-low 423.

The number of American adults who cannot read is disturbing, but the increase in the number of American adults who cannot read is more disturbing. In 1930, 1940, and 1950 about 3,000,000 citizens—most of them residents over age fifty who had never been to school—could not read. President Lyndon Johnson said five million—most of them young adults with six to twelve years of schooling—could not read in the early Sixties. In 1970, twelve to seventeen million young adults with at least eight years of school attendance were illiterate. By 1980, the number of non-reading young adults had ballooned to almost thirty million.

In 1990, data from the U.S. Department of Health & Human Services, Justice, Labor, Commerce, and the Census, together with twenty years of scores on U.S. Department of Education tests administered to fourth-grade, eighth-grade, and eleventh-grade students by the National Assessment of Education Progress, indicated thirty-five to forty million Americans could not use a phone book or read road signs, maps, menus, election ballots, can labels, car manuals, nursery rhymes, newspapers, The Bible, The Declaration of Independence, The Constitution of the United States, or directions on a bottle of medicine.

Over ninety-nine percent of public two-year colleges in the United States have remedial reading classes. In the State of Oklahoma, eighty-one percent of students graduating from high school and entering Vocational-Technical (Vo-Tech) schools must first learn to read prior to learning technological skills. About eleven million public school students (one in four) in all grades are doing primary grade school lessons in very small, very expensive, Chapter 1 remedial classes or Special Education classes for the disadvantaged and disabled—although nine of ten enrolled in remedial or Special Education compensatory programs have normal sight, hearing, and intelligence with no diagnosed physical or mental handicaps.

American teachers, parents, and governmental agencies do not realize the catastrophic decline in literacy started during the Thirties rather than during the Sixties. The only event correlating to a decline in literacy beginning sixty years ago is the switch from phonics instruction to whole word recognition instruction.

Professional educators wanted whole word recognition instruction to succeed because phonics instruction presents difficulties. Whole word recognition instructors complain that phonics is difficult to teach because many sounds in the English language are spelled inconsistently. Only thirteen percent of English words do not follow phonetic spelling rules, however, and most of the thirteen percent contain only one maverick syllable spelled in a strange way. Designers of voice recognition computers say eighty-seven percent of English words follow phonetic spelling rules. Beginners can easily learn fifty to sixty common exceptions to phonetic spelling if the beginners first learn 1,000 words which follow the rules.

Too many years of trying and failing to make sight repetition instruction succeed has taken a terrible toll. In three years, students with good sight memories learn to recognize 1200 to 2000 most-used words by the words' shapes. The students learn the 1200 to 2000 most-used words from teachers who say the words over and over again and with readers which use each new word fifteen to twenty times in programmed stories.

But a vocabulary of 1200 to 2000 words is not enough for a third-grade student. In grades 4 through 8, third-grade see and say readers must add at least 20,000 new words to their reading vocabularies in order to read high school textbooks. Teaching 20,000 new words in five school years by see and say instruction is an impossible task. Ironically, one or two unfamiliar words can make nonsense out of paragraphs filled with words that third-grade see and say readers spent three years learning. In contrast, second grade phonics readers can sound out almost any word in a high school textbook. The second grade phonics reader may need definitions for words not in the reader's speaking vocabulary; and the phonics reader may need explanations for comparisons and references. But the phonics reader can read the words.

Sir James Pitman developed an Initial Teaching Alphabet (I.T.A.) in the Sixties to teach children to read by matching sounds with sight. Strictly a teaching tool, the I.T.A. sought to overcome a disparity between sounds children know in their heads and symbols children see on a printed page. The children confront a code, Pitman said, wherein the code is the English language. Over 40 distinct sound units of English are spelled in a variety of ways, and letters appearing in a variety of forms—capital, lower-case, printed, and handwritten—can be baffling.

I.T.A. proponents believed the baffling code of the English language sabotages conventional methods of teaching reading. The “look-say” method (as it was described in Time Magazine) tries to link a visual pattern of a word with the word's meaning, only to run up against confusing variations of form (all three letters of “AND” look different from those of “and,” for example).

Also difficult is trying to apply the phonic method, which teaches children to single out letters and their phonemic values so that they can read and spell analytically. In the 26-letter alphabet, one letter often represents different sounds in differing words—for example, the o in gone, one, go, do, women. One sound may also be spelled in different ways—for example, the sound common to I and eye has 22 different spellings in words from aisle to buy to style. Time 83:52 (Apr. 3, 1964).

The I.T.A. erased inconsistencies by linking specific sounds to specific symbols. An all-lower-case alphabet included 44 characters—24 of 26 existing Roman letters (no q or x), plus 20 new letters consisting mostly of typographically linked digraphs. Each of the 44 I.T.A. symbols represents only one sound, and beginning readers can be confident the word seen in print is what the reader says in sound.

The I.T.A. delivered consistency and offered great promise. The Ford Foundation funded an experiment at Lehigh University's reading and study clinic to teach 3,000 children in Pennsylvania, New York, New Jersey, Illinois, Ohio, Minnesota, and California by the new I.T.A. Dr. Albert Mazurkiewicz, director of the Lehigh clinic, predicted nearly all U.S. schools would adopt the new I.T.A. system in time. About 2,500 observers visited Lehigh to learn about the I.T.A. in 1964.

Despite its consistency, the I.T.A. also has problems. Students having good sight memories learn a phonetically correct but alphabetically incorrect spelling. After an initial flurry of activity and interest, the I.T.A. was not adopted by U.S. schools and is all but forgotten. As of 1994, according to Wood, the United States was left with almost thirty million illiterate adults.

According to recent research, it does not appear that a solution to the literacy issues facing the United States has emerged since 1994. In 2003, according to the National Assessment of Adult Literacy (NAAL), conducted by the US Department of Education, it was found that fourteen percent of American adults scored at a “below basic” level in prose literacy in English. More than half of these persons did not have a high-school diploma or GED. 39 percent of persons at this level were Hispanic; 20 percent were black; and 37 percent were white. According to the National Center for Education Statistics, “results showed that the average quantitative literacy scores of adults increased 8 points between 1992 and 2003, though average prose and document literacy did not differ significantly from 1992. Among blacks, average prose literacy scores increased by 6 points and average document literacy scores rose by eight points between 1992 and 2003. The average prose scores of Asians/Pacific Islanders increased as well, rising 16 points between 1992 and 2003. The average prose literacy scores of Hispanics fell 18 points from 1992 to 2003, while average document literacy scores decreased by 14 points. Average prose and document literacy scores among whites did not change significantly.” Literacy among college graduates declined between 1992 and 2003, with less than one-third of all graduates at the highest “proficient” level in 2003, and less than half of all graduates with advanced degrees at this level. As those in the education field can appreciate, there is a strong need for a program that addresses the difficulties of reading English using a phonetic based system while focusing on the vowels, which typically give English readers the majority of the problems. Additionally, as English is one of the most widely used languages in the world, many people would like to acquire good command of it. However, different people learn by different methods, in which learning English through English phonetic symbols is one of the common methods. Currently, the most popular English phonetics are the Kenyon-Knott Phonetics, the Jones Phonetics and the Webster Phonetics. Despite the three types of phonetics that have been in use for decades, each of them has a certain degree of flaws. First, both Kenyon-Knott and Jones Phonetics take the International Phonetic Alphabet (IPA) as their phonetic symbols. Although the IPA has the advantage of being able to be used as phonetic symbols for other languages, however, for learners who only wish to learn English, IPA becomes an extra burden because the IPA has a lot of unfamiliar and easily mistaken symbols, and many symbols that can be found in the English alphabet but are pronounced differently. See http://en.wikipedia.org/wiki/Literacy

To aid in solving the literacy problem, assist those desiring to learn English as a second language and deliver on the promise of the “No Child Left Behind Act”, an engaging rule based method of is needed to teach children and adults how to read English.

### SUMMARY OF THE INVENTION

### Description of Methodology

Generally, the Voweletics™ reading program is a curriculum for teaching the reading of English with a particular focus on the vowels found within words. The Voweletics™ reading program is a curriculum comprised of 10 lessons with step-by-step instruction. It is particularly well suited for implementation as an interactive program for young readers, ages 6-10. The vowel based method of teaching the reading of English may be implemented in numerous ways including through a stand alone reading program, a student-mentor type reading program, a student-parent type reading program, as one part of a curriculum for teaching reading, a television show, an interactive DVD, a downloadable computer program and or an interactive computer tutorial.

Some embodiments of the present invention provide a vowel based method of phonetic reading which is applicable on any visual media that can be displayed, projected, printed, etc. It is within the scope of the present disclosure and claims to implement the vowel based method through or by a medium, a plurality of words disposed on the medium, and a plurality of characters disposed on the medium. In some embodiments the medium comprises paper, for example, however in other embodiments, the medium comprises a “virtual medium,” similar in respect to an encoded file that is human-perceivable with a word-processing, translation or other similar software program. A virtual medium can both be perceived on a screen as well as saved onto a computer-readable medium, such as a magnetic or electro-optical disc for example. The virtual medium can be further manipulated and will be further discussed below.

In another embodiment, the instruction may be segmented into ten lessons and intended for both student and a mentor. The Voweletics™ method trains both the student and their mentor using its very specific phonetic techniques. All of the program's components may be designed for interactive use with the student and mentor. It has been found that when the student is a child, and a knowledgeable mentor having an understanding of how to reinforce the program's basic concepts is involved, outstanding results follow. Although originally intended to be used with children, it is believed that the benefits of mentoring are also valuable to students learning to read English as a second language.

The Voweletics™ methodology utilizes a precise, consistent approach to decode unfamiliar words. This methodology equips the reader with strong, word attack skills. The Voweletics™ method for teaching reading which creates a THINK System simulating the internal processing readers use to determine correct vowel phonemes (sounds). Eighteen varying vowel phonemes are placed into three vowel classifications. The three vowel classifications are used within the framework of three Voweletics™ rules to determine which vowel phonemes are used to correctly pronounce words. Students use the LOOK! THNK! READ! System when reading unfamiliar words. This system then teaches:

1. LOOK at the vowels first;

2. THINK which sound the vowels will make; and,

3. READ the word

### Think System

The Voweletics™ teaching method is designed to create a THINK System simulating the mental process readers go through in determining the correct vowel phonemes to use when decoding words. Before beginning to read the word, Voweletics™ teaches the reader to first LOOK at the vowels in the word. Next, the reader will THINK which vowel phoneme will be heard according to the methods taught throughout the program. Once the vowel phoneme is determined, the reader proceeds to READ the word with the correct vowel phoneme inserted. It is intended that the THINK System is applied until the reader has automatic recall of the vowel patterns taught in Voweletics™. Voweletics™ takes 18 varied vowel sounds and classifies them into three types of vowel phonemes: short, long & special.

To further improve introduction, memorization and re-inforcement of the concepts taught by the Voweletics™ method, many of the program's components are color-coded and consistently applied throughout the materials to the three types of vowel phonemes. The THINK System reduces the common reading error attributable to many readers wherein the reader knows the beginning consonant sound and incorrectly guesses at the word due to a lack of vowel phoneme awareness. Voweletics™ method is constructed to teach LOOK! THINK! READ! using a three-step approach based on memorization of the vowel phonemes, determination of the vowel phoneme and application to the word to be read.

The THINK System grids reduce the core of the Voweletics™ curriculum into a simplified visual clue. The grids simulate the mental process in determining the correct vowel phoneme. Exact word verbiage used throughout the teaching process is provided on the grids to prompt readers' recall of Voweletics™ methodology. These grids appear as visual prompts within many components of the program. Consistent repetition utilizing multi-sensory teaching components further cements the Voweletics™ THINK System for readers. Voweletics™ provides numerous components for application. The grids which exemplify the decoding process, easily serve as visual reminds for older students given Voweletics™ instruction in younger years. The easy transfer enables students to decode complex grade appropriate material.

### Mentoring

The inventor has found that mentoring enables learning. Therefore, the Voweletics™ method may be implemented through a comprehensive, systematic curriculum for delivery to both a mentor and a student. This is especially useful if the student is either a younger child just learning the reading process, a child challenged by a reading disability, or an adult having confidence issues related to the shame of illiteracy. When the student has a knowledgeable mentor specifically trained using the same reading techniques as that of the reader, the reading and writing process is accelerated and confidence is gained. The Voweletics™ methodology enables the mentor to assist the student. The methodology is written in layman terms and may be shared with both the child and the mentor. The mentor provides one-on-one assistance to reinforce the phonetic tools learned in the Voweletics™ program. This mentor component expedites transfer of instruction and continual reinforcement, laying the foundation for academic success.

### Visual Clues Enable Learning

The Voweletics™ LOOK! THINK! READ! charts presented throughout the materials link the vowel with its vowel placement within a word to increase the probability of appropriately determining the correct vowel phoneme. The pictorial clues provide a prompt to draw the vowel sounds from memory. This concise, easy-to-follow guide allows readers to reference it to successfully determine correct vowel phonemes. As applied, the reader simply finds the vowel used in a word along the left side of the chart. The top part of the chart allows the reader to find where the vowel is placed in the word. The intersection of the vertical and horizontal columns provides a pictorial clue to draw the correct vowel phoneme from memory. This charting culminates the process of the Voweletics™ THINK System and displays the THINK grid that simulates the mental process the reader is taught to go through to determine the correct vowel phoneme.

### Multi-Sensory Learning

Voweletics™ utilizes a multi-sensory methodology applying left brain/right brain tendencies to solidify the teaching principles. The Voweletics™ principals are taught using both the analytical and creative sides of the brain. Through the use of songs and character drawings a strong right brain element is brought to the program. The human-like qualities the characters are given through song lyrics and pictorial representation allows the reader to identify with the clue characters for easier memorization. Students that are “left” brain dominant are many times more logical and analytical. By comparison, students that are “right” brain dominant many times focus more on creativity and or feelings and emotions. The combination of charts and grids provide systems that are readily absorbed by the left brain while the combination of words, stories and characters support right brain function. A program offering both is better for all students and stimulates overall development versus a one-sided learning approach. Students have different learning styles. Voweletics™ approaches learning with utilization of a multi-sensory approach: visual, auditory, and kinesthetic. Using the many multi-sensory Voweletics™ components as identified below, attachment to a personal learning style increases the reader's success.

### Multi-Colored Phonetic Readers

Concepts learned from the Voweletics™ reading program are brought to application in the Phonetic Readers. In one embodiment, the completely unique Phonetic Readers have the vowels which follow a phonetic pattern accented in the appropriate color based on whether the short, long or special vowel sounds apply. This component draws the student's eye to the vowels when encountering an unfamiliar word and encourages the application of the THINK System stimulated by the application of the Vowelectics™ method. LOOK at the vowels first, THINK which sounds the vowels say determined by their placement in words, and then READ the word. The student and mentor may review the Phonetic Readers until the reader has automatic recall of the vowel patterns taught in Voweletics™.

The Phonetic Readers may also be based on the life experiences of the five short vowel characters (Antly, Eggly, Iggly, Oxly and Uggly). Again, this system allows for re-inforcement of the concepts shown through music, characters and colors. Each Phonetic Reader exemplifies the human qualities presented in the program's songs. These personal qualities give students feelings they can identify with. This identification not only helps cement the character in their mind to remember the associated vowel phoneme, but also addresses social issues young children may experience in life.

### Social Issues

Social issues can impair a child's learning. The Phonetic Readers use guided phonetic vocabulary for vowel application while giving real solutions to the social issues children face. The social issue that each short vowel character is identified with is listed below:

| | |
|---|---|
| Antly | Value of having a good attitude |
| Eggly | Strategies to reduce feelings of |
| | anxiety |
| Iggly | Importance of being nonjudgmental |
| Oxly | Qualities of good friendship |
| Uggly | Kindness and empathy towards |
| | others |

### Vowel Finder

Another aspect of the reading method disclosed herein is an apparatus to assist in implementation of the reading methodology. Named the Vowel Finder by the inventor, the Vowel Finder in the Voweletics™ reading program is designed to promote and facilitate improved identification of the vowels found in words. The Vowel Finder may be a rectangle made of clear plastic. It may have a thin opaque line, which may be colored, to help readers locate vowels in words. The Vowel Finders are clear so that students may see the entire word, which promotes correct word processing; yet is able to break the word into smaller parts or syllables to aid the process of correct vowel phoneme determination. Students are able to slide the Vowel Finder from vowel to vowel. It may also be used to count the consonants between the vowels to help determine the correct vowel phoneme. The Vowel Finder may be combined with the flow chart of the present method in book mark or cheat sheet type form or it may be combined with a simplified version emphasizing the rules of the method and the guide words or guide word characters. In another version, the vowel finder may be combined with visual clue cards or flash cards.

### Methods of Presentation

Voweletics™ presented in the LOOK! THINK! READ! format is a vowel based method of teaching the reading of English that may be delivered to the student in the format of paper workbooks, video or classroom presentations, songs, music, computer software, or a combination thereof. For example, the individual reading and writing exercises may be presented in a workbook format such that the exercises occupy individual worksheets in the workbook. Alternatively the teaching may be used as computer software such that the student interacts with a computer system to complete some or all of the exercises. In another embodiment, the method may be executable as a software program stored on a computer readable medium in a computer memory storage device, such as a computer hard drive, a floppy disk drive, a CD-ROM drive, or other conventional devices. The user may utilize a user interface device such as a keyboard, computer mouse, touchscreen, or a combination thereof, to execute the method from the computer memory storage device using a central processing unit. The display device may be used to display the various images, instructions, and exercises of the method. The computer system may include an audio speaker device for delivering audible instructions, readings or feedback to the user. In addition to the computer system, a workbook may be used in conjunction with the computer system to provide the student with further instructions and a tangible medium for particular reading and writing exercises.

The present invention provides a vowel based phonetic method and apparatus for teaching students, adults and people desiring to learn English as a second language how to read English.

An object of the present invention is to provide an aid for teaching reading so that a single voweletic unit is matched to its correct phonetic sound based on its position within a word formed from the standard English alphabet. As coined and defined by the applicant, a voweletic unit is a single group of graphemes that is a constituent of a word consisting of at least one vowel and its relationship with adjacent consonants following the vowel and/or another vowel to determine a vowel phoneme (sound).

An object of the present invention is to provide an aid for teaching remedial reading or English as a second language to produce an almost immediate improvement in the reading of English.

Another object of the present invention is to provide a program that unifies the vowel based phonetic approach and method to the teaching of English that may be replicated across methods, programs, teachers, classes and students.

Another object of the present invention, while accomplishing the above stated object, is to provide an aid for teaching reading phonetically with a focus on the vowel portion of the words so that students learn how to identify the sound letters are intended to make based on the vowel and the positive of the vowel within the word in a systematic and logical fashion to form words.

Yet another object of the present invention, while accomplishing the above stated objects, is to provide a vowel based method for teaching the reading of English with a program that may incorporate students with a mentor or parent. The Voweletics™ method trains both the child and their mentor (or parent) using its very specific phonetic techniques. All of the program's components may be designed for interactive use with the student and mentor.

Other objects, features, and advantages of the present invention will become apparent from the following detailed description when read in conjunction with the drawings and appended claims.

### DETAILED DESCRIPTION—DRAWINGS

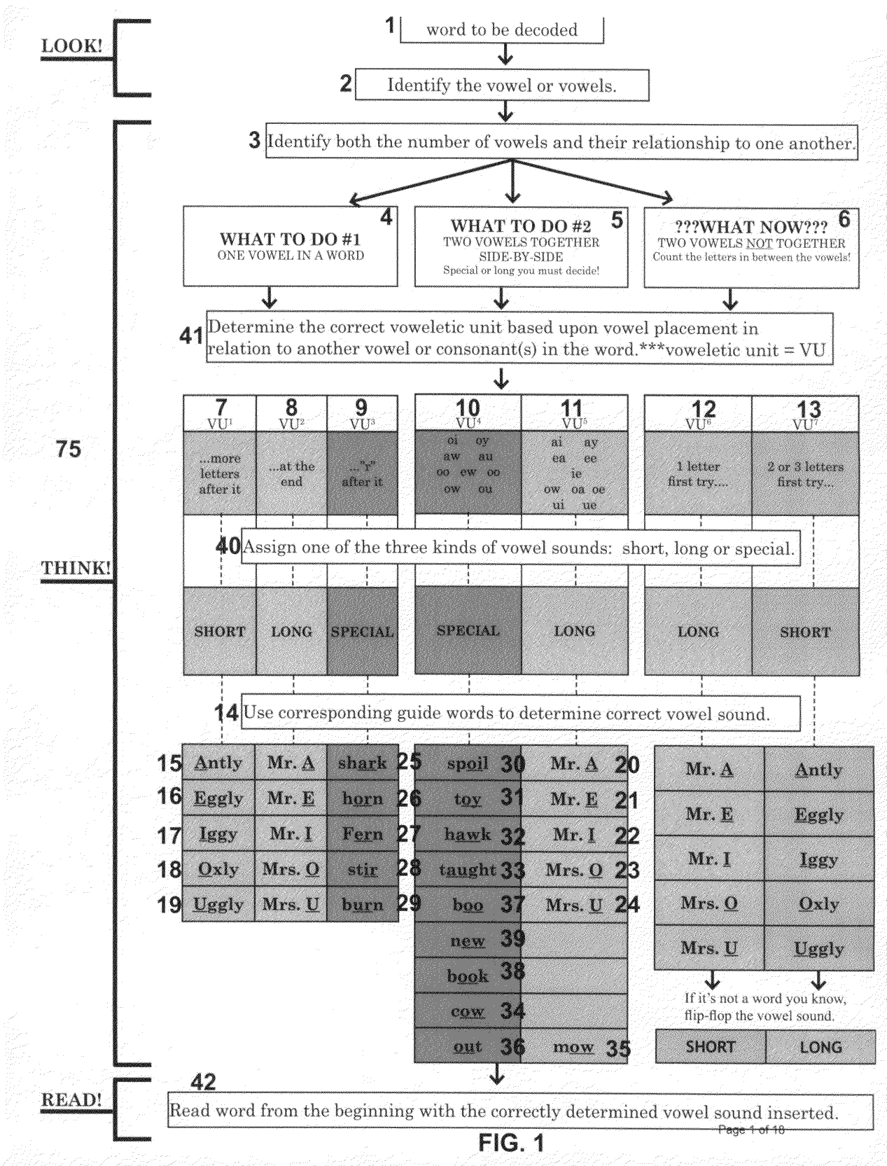

FIG. 1 is a flowchart illustrating the steps involved in teaching a student the LOOK THINK READ method of the present invention.

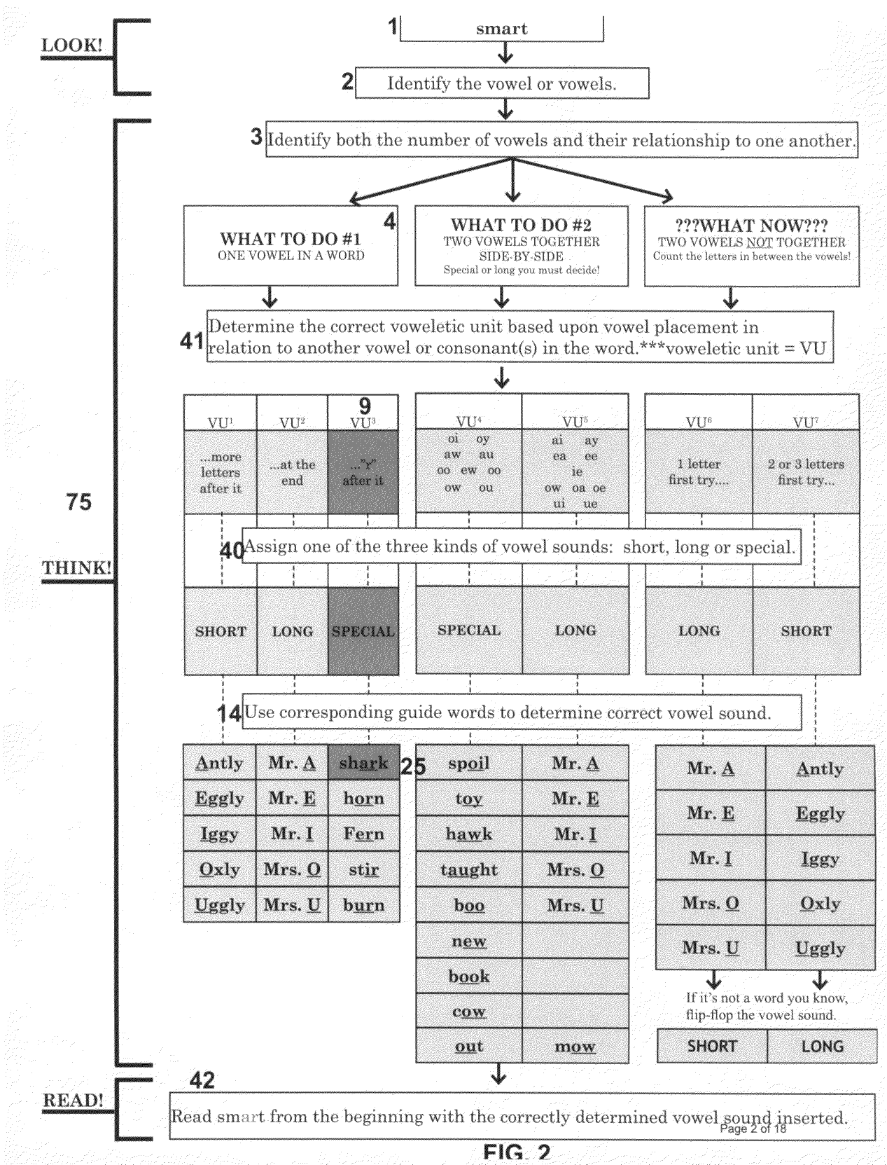

FIG. 2 is the flowchart of FIG. 1 illustrating application of the LOOK THINK READ method to a word.

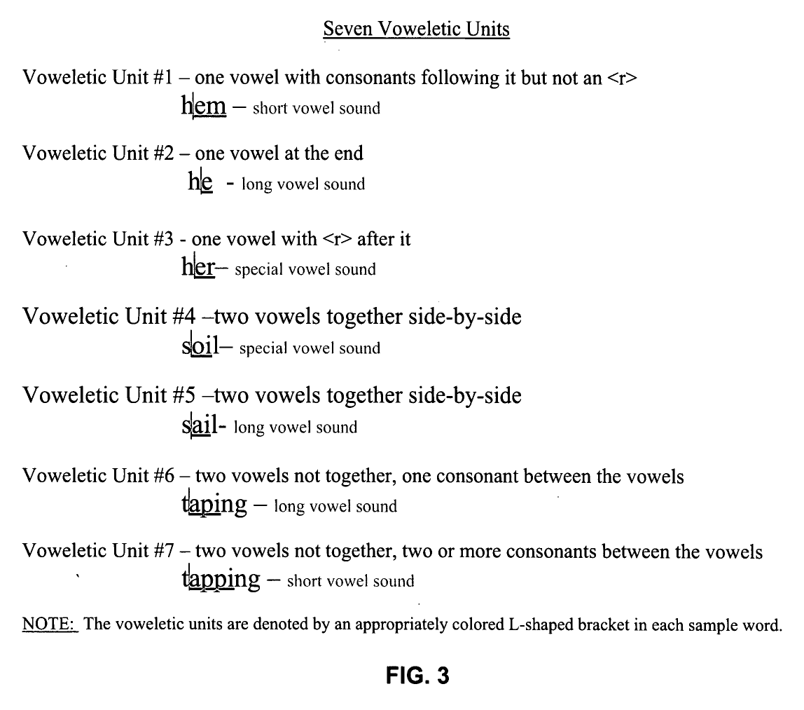

FIG. 3 lists the seven (7) voweletics units along with an example.

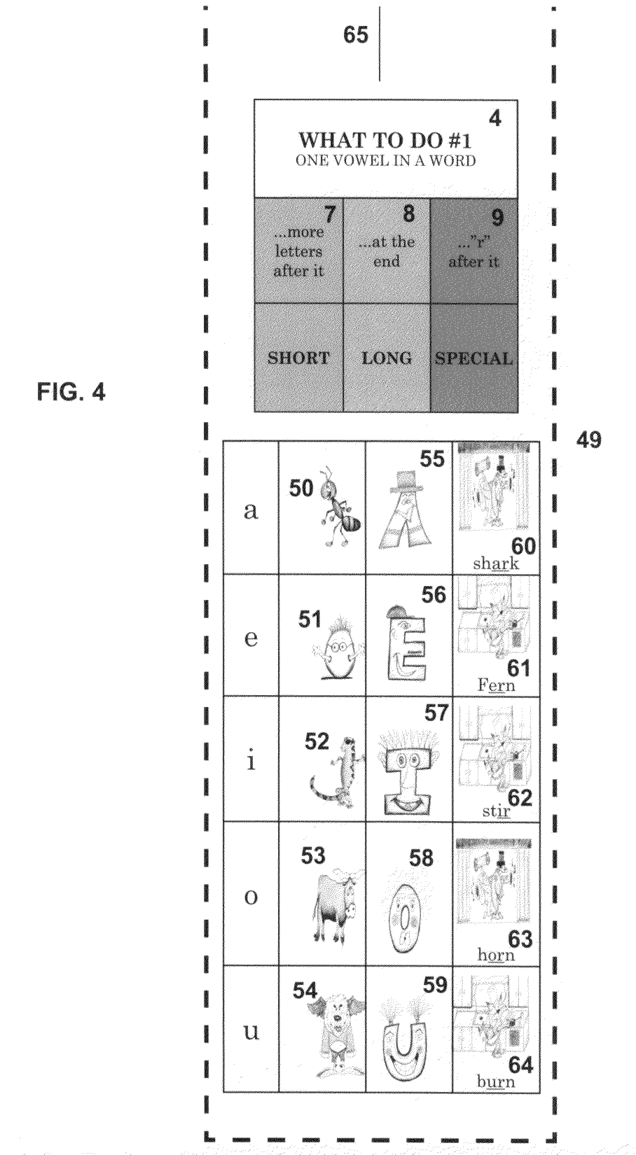

FIG. 4 is an article of manufacture such as a bookmark or printed sheet that is color coded illustrating the guide word characters with the rules of the method.

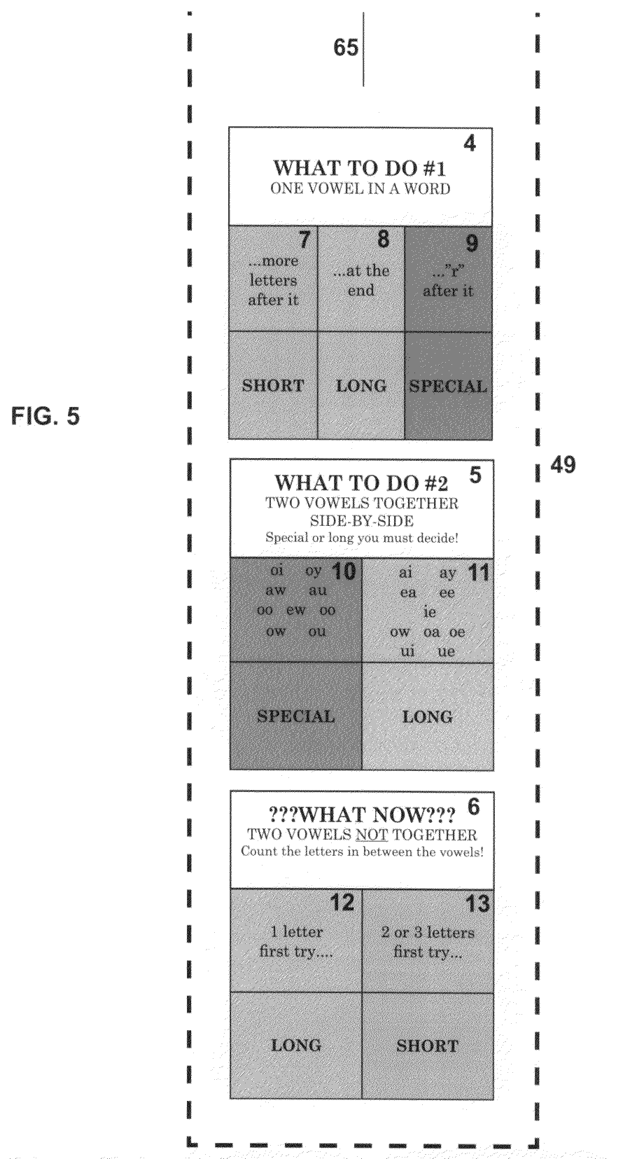

FIG. 5 is an article of manufacture such as a bookmark or printed sheet color coding in combination with the rules of the method.

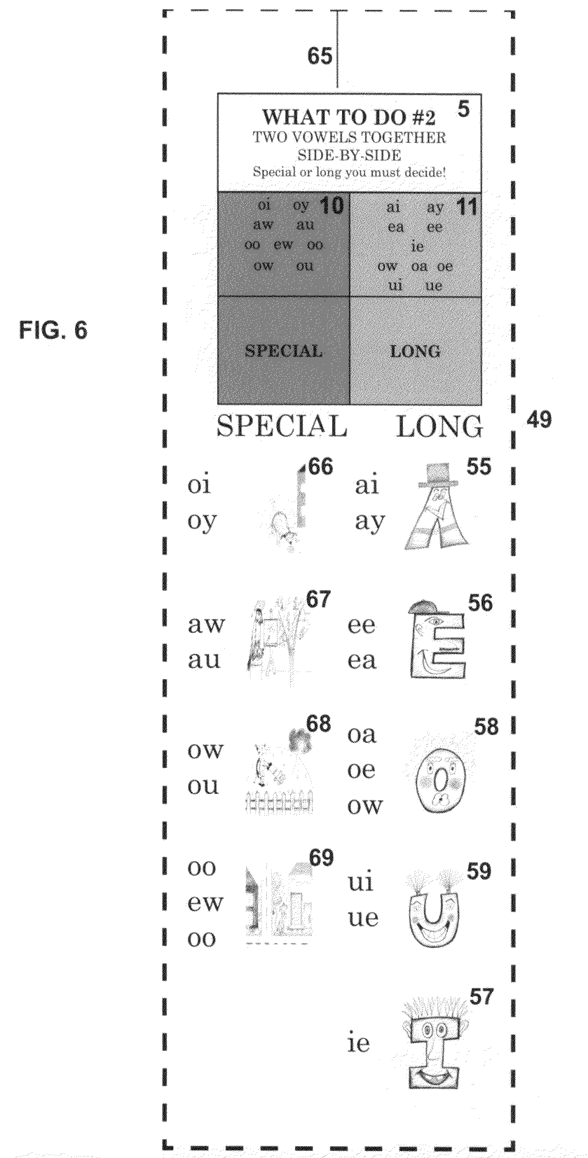

FIG. 6 is an article of manufacture such as a bookmark or printed sheet that is color coded illustrating the guide word characters with their respective sounds and spellings and the rules of the method.

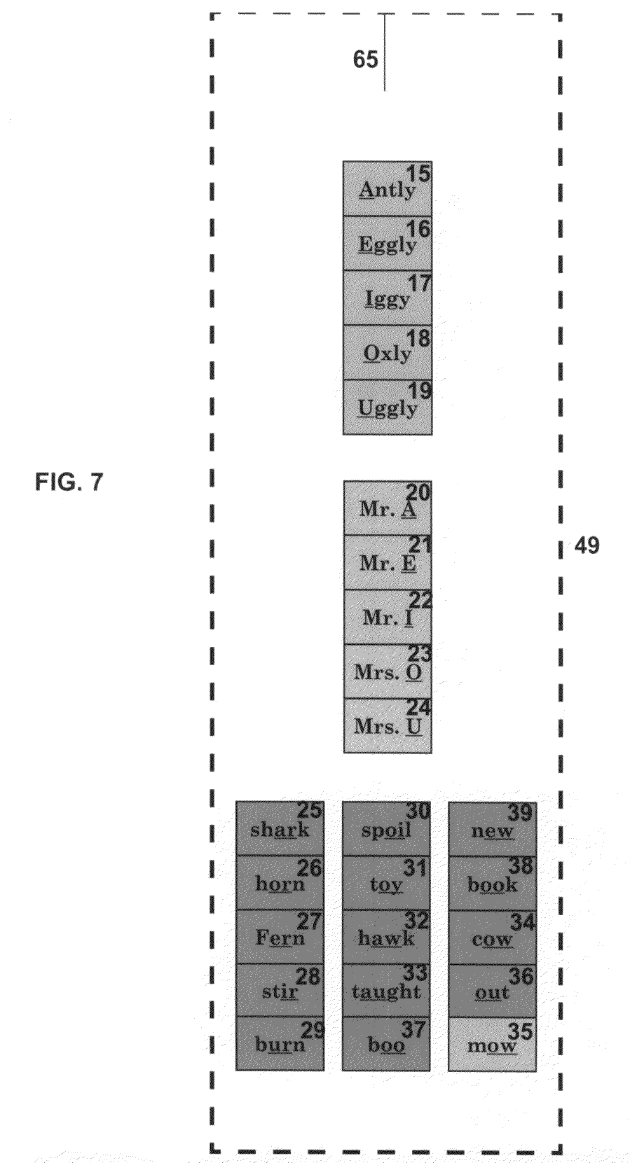

FIG. 7 is an article of manufacture such as a bookmark or printed sheet that is color coded illustrating the guide words for their respective assigned sounds (i.e. short, long, special).

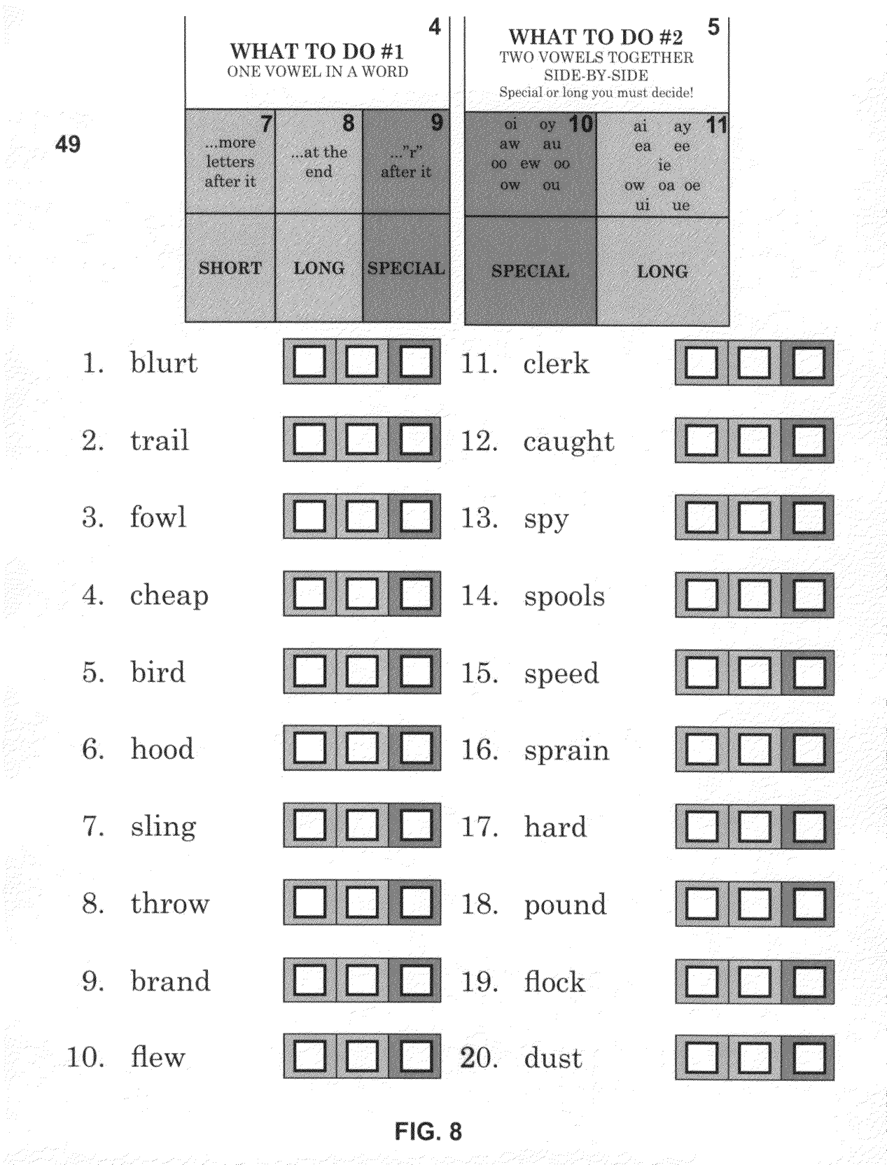

FIG. 8 which is an example of a color coded review lesson.

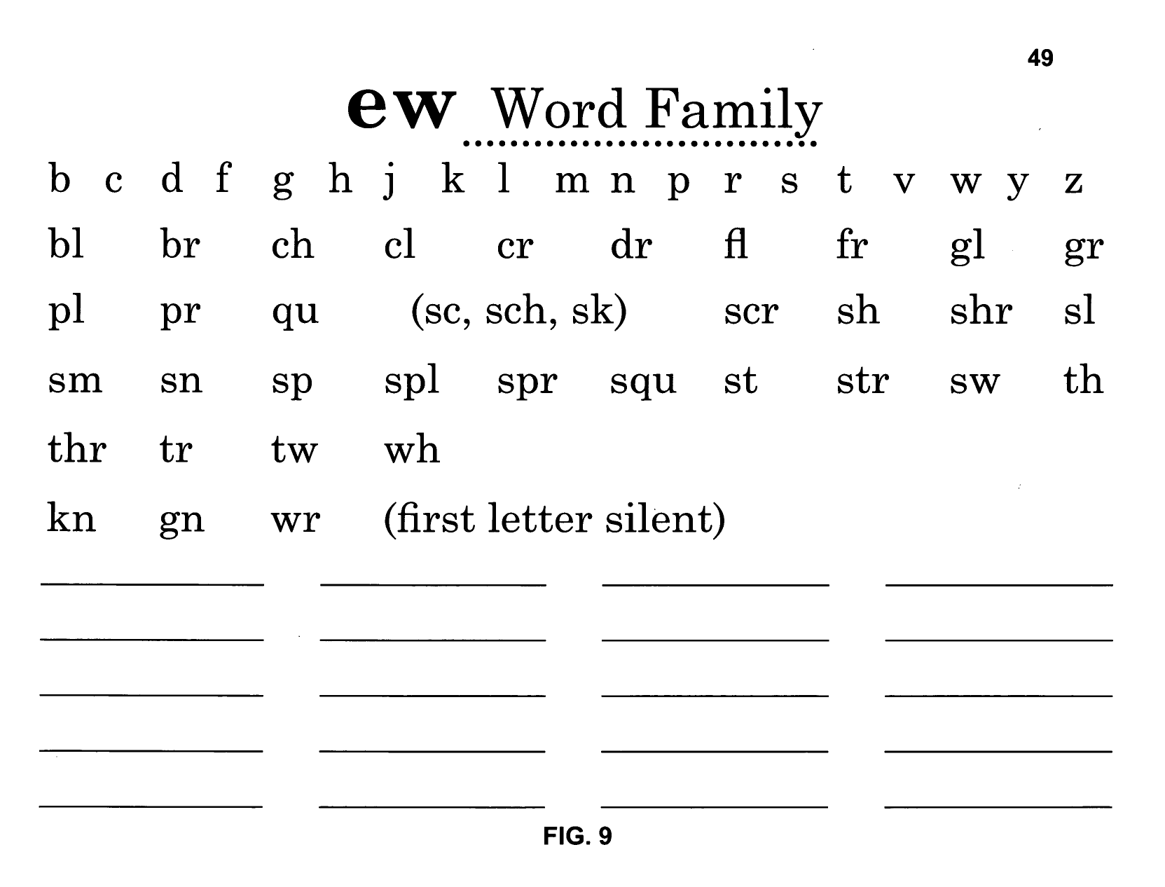

FIG. 9 illustrates an example non-color review lesson.

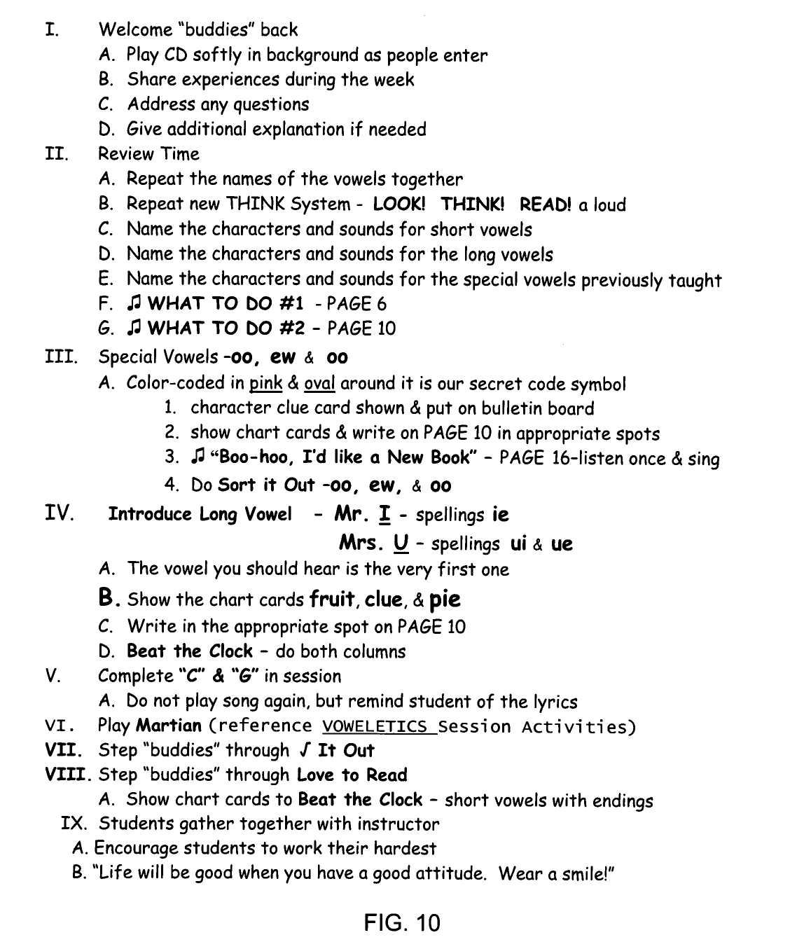

FIG. 10 illustrates an example lesson plan incorporating music and songs.

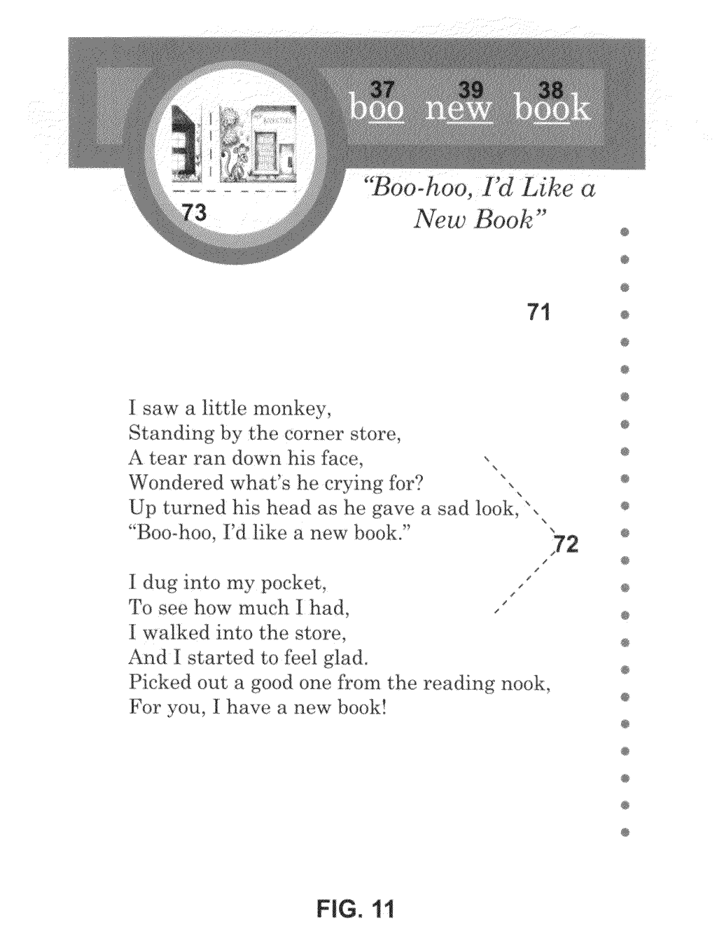

FIG. 11 illustrates an example of a songbook page to aid in identification of guide words with a grouping of vowel phonemes.

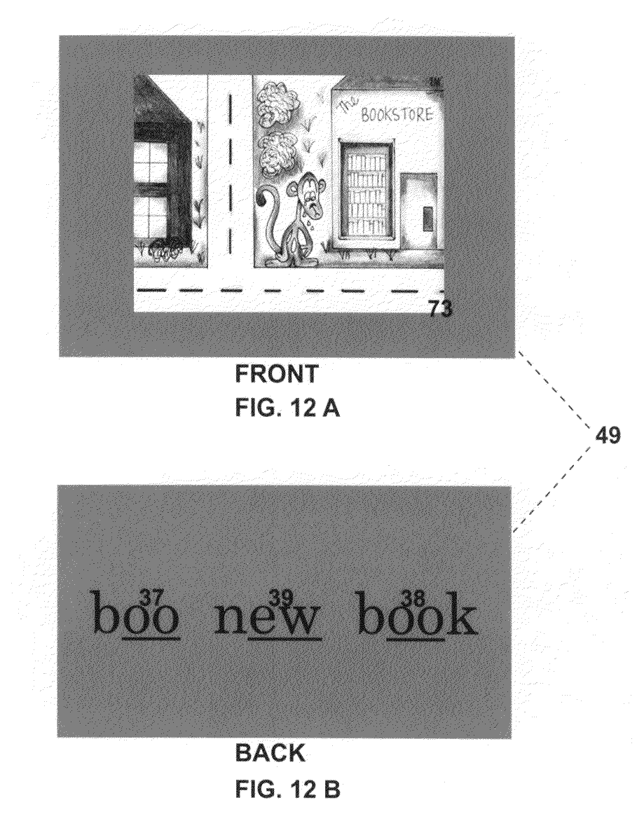

FIGS. 12A and 12B collectively illustrate the front and backsides of a sample flash card implementing the characters and stories chosen to teach the method of the invention.

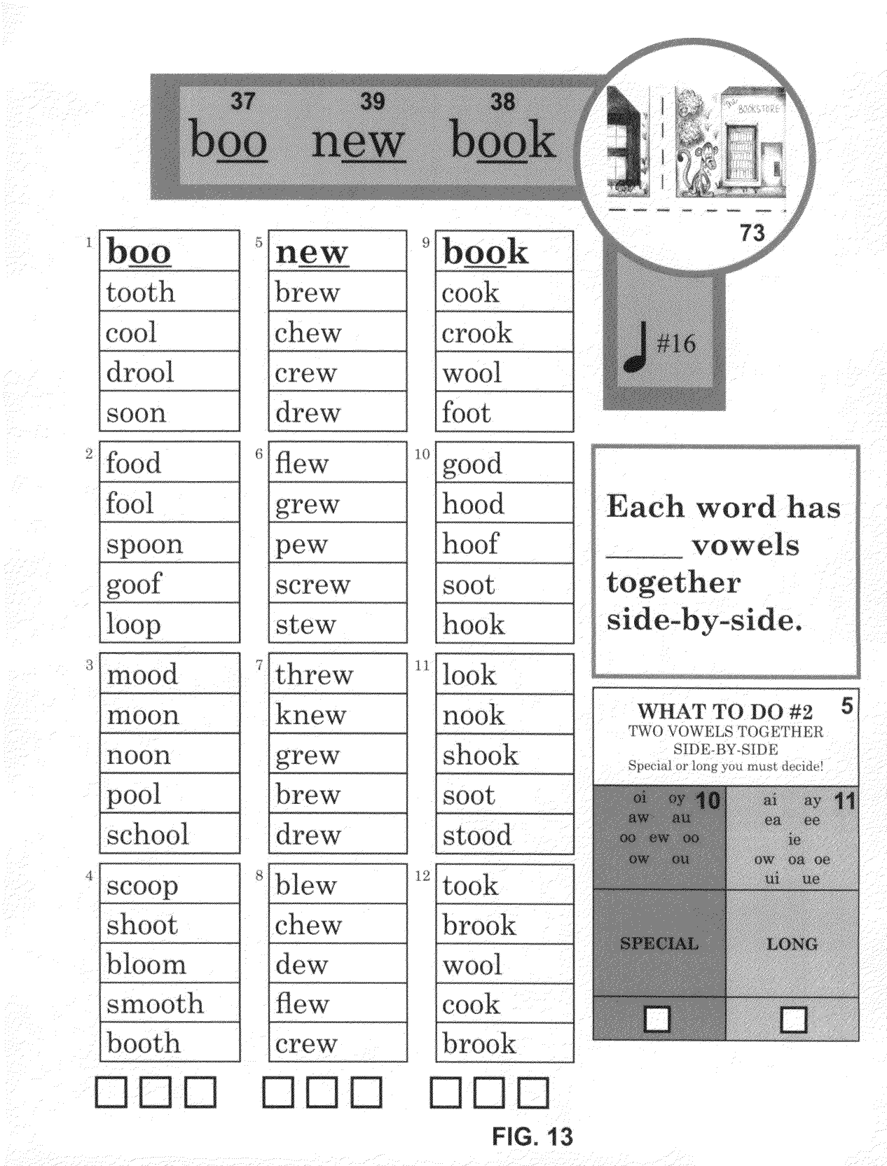

FIG. 13 illustrates an example of a guided vocabulary workbook page for application of isolated skills.

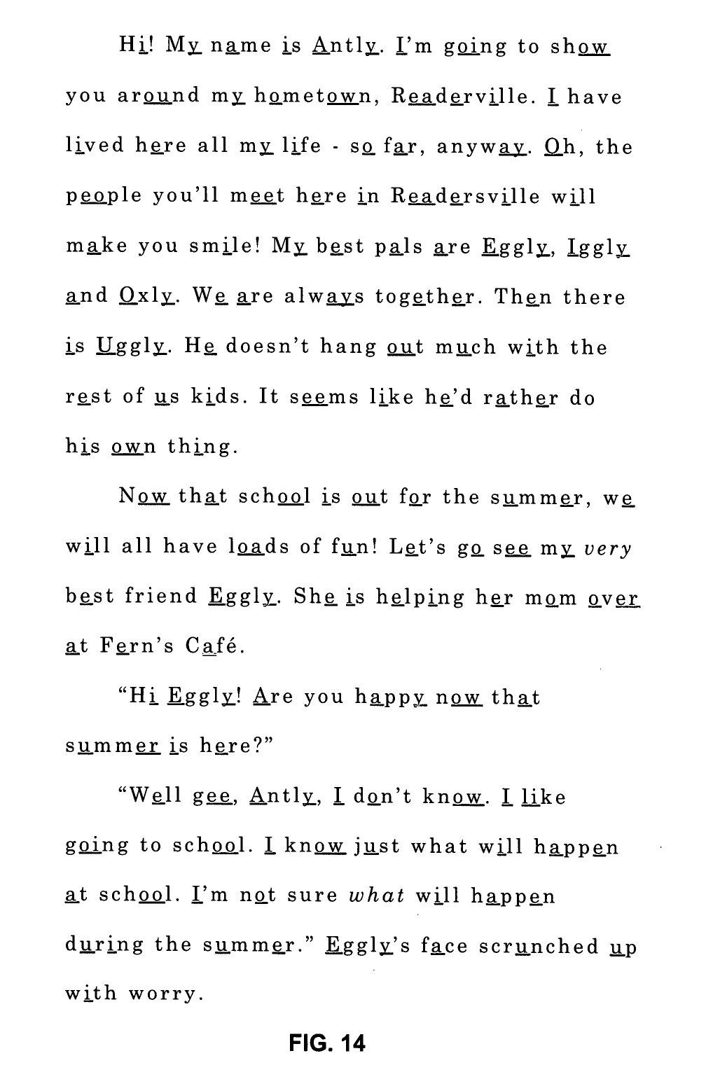

FIG. 14 illustrates an example of a phonetic reader that may be used to implement the present invention.

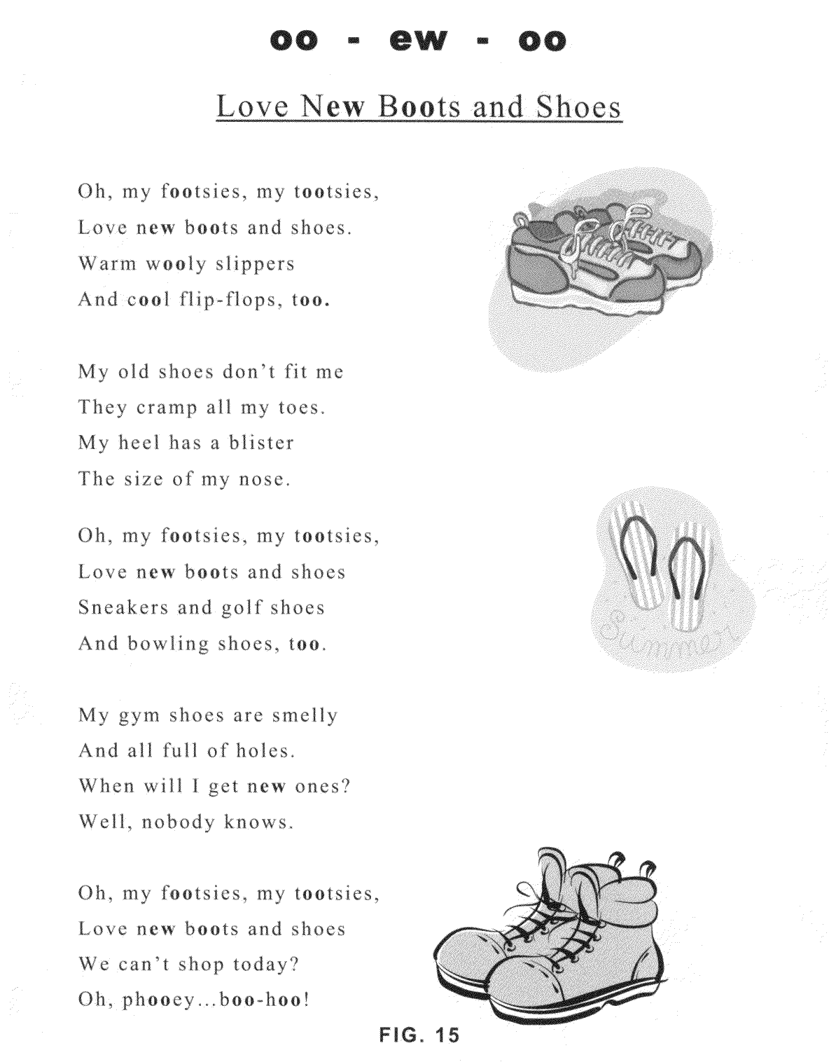

FIG. 15 illustrates an example poem that may be used to implement the present invention.

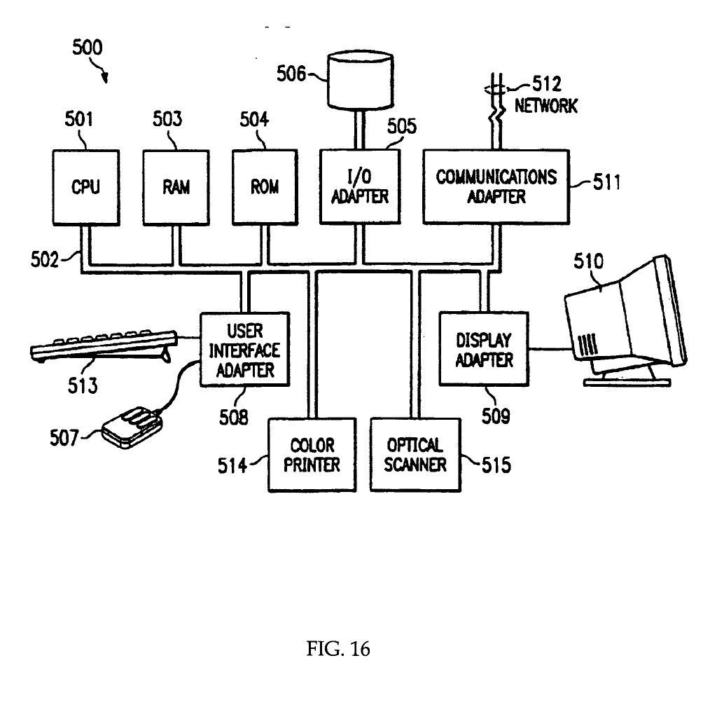

FIG. 16 illustrates an embodiment of a computer system that may be used to implement the present invention.

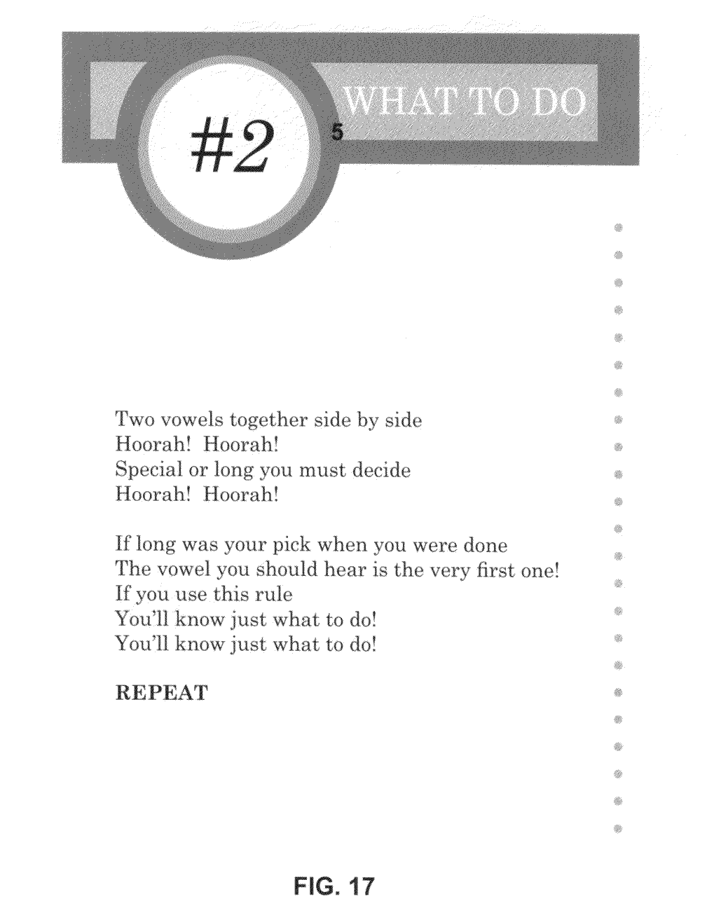

FIG. 17 illustrates an example of a songbook page to aid in memorization of a vowel rule.

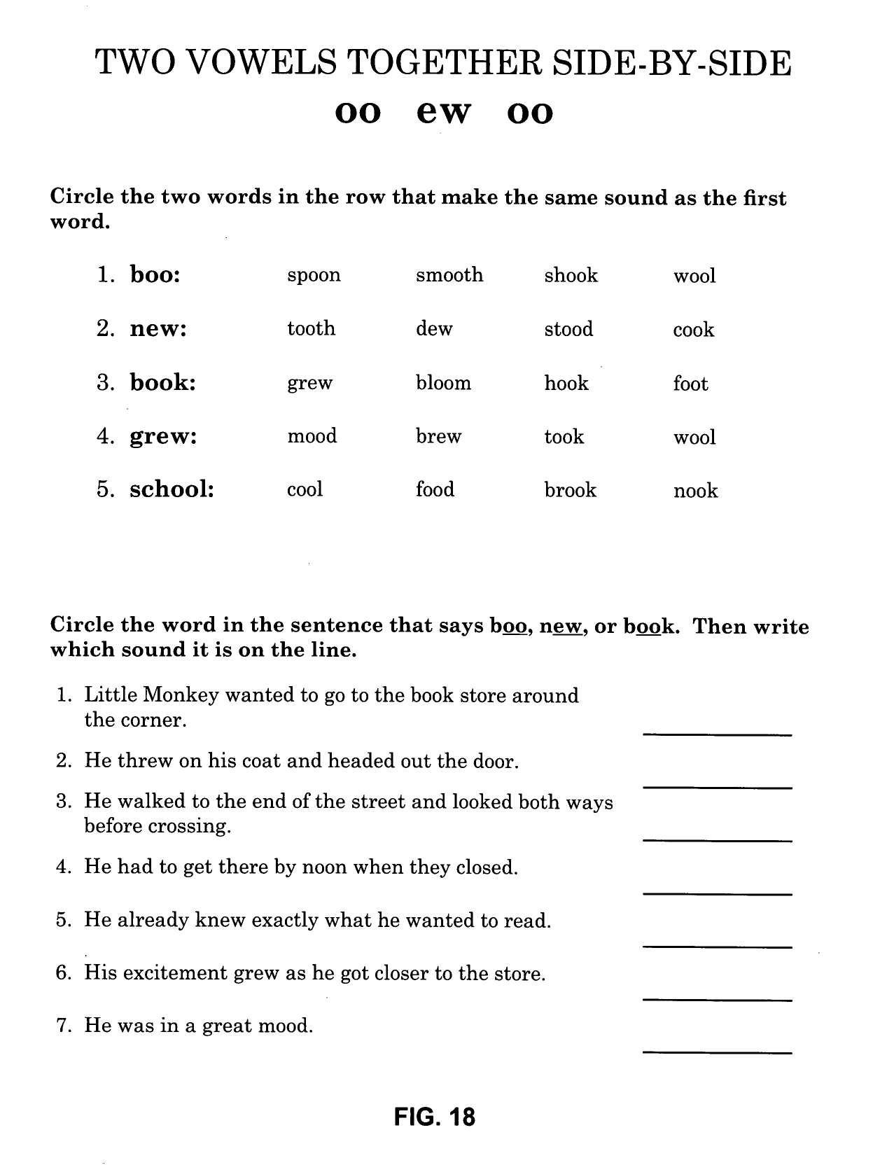

FIG. 18 illustrates a workbook page for application in identification of words with similar vowels phonemes with a text.

### DETAILED DESCRIPTION

As illustrated the accompanying FIGS. 1-18, applicant has developed and does claim a vowel based method of learning the reading of English which applicant has defined and branded “Voweletics™”. The proper definition for the term vow•el•et•ics (voul' [symbol] l \check{e}t' \check{i}ks): n. Linguistics. 1. a vowel based method of learning the reading of English comprising of identification of vowels and their relationship to either another vowel and/or another consonant(s) in a word to determine vowel phonemes; or, 2. a vowel based method of teaching the reading of English with primary focus on the vowels through the use of creative instruction, exercises, songs and games engaged in by the reader. The term can also be used as an adjective as in “1. of, relating to, or involving description of linguistic phenomena considered in isolation from a particular system or in relation to predetermined general concepts; or, 2. of, relating to, the practice or principle of vowel identification in relation to adjacent consonants following the vowel and/or another vowel to determine vowel phonemes.”

The Voweletics™ method may be applied to groups of 10-50, although it can be used for fewer students, even one. If mentors and or parents are involved, the program may be scaled to larger number of “students.” Typically, the persons benefiting directly from this method have been referred to as “students” or “readers” or “participants”. However, the term “student” conveys the mental image of a young person or young adult who is enrolled in classes. Because the this invention is not limited to use by these traditional types, but is equally adapted to others who do not fit that image, the users of this invention hereinafter are simply referred to as “readers”. Readers may be mature people or others who are non-traditional students. They may be working adults, parents, grandparents or people who simply want to improve their reading skills. Readers may also English as a second language students or those wanting to learn English as a second language.

In one embodiment of the present invention, the reader first learns to identify an individual word to be decoded, which is composed of at least one consonant and at least one vowel. (1 in FIG. 1) Next, the participant learns to identify a first vowel grapheme (reading from left to right, as is natural in English) occurring in the individual word to be decoded. (2 in FIG. 1) A grapheme is defined as a basic unit of writing language, and a vowel grapheme is further denoted herein by brackets, and selected from the group consisting of <a>, <e>, <i>, <o>, <u>, <y> or <w>. It should be noted that <y> is a consonant that when combined with certain other vowels modify the correct sound to be expressed in English; the word “hawk” is a word of this nature as will be discussed further herein. The reader may understand these concepts before undergoing a lesson or program implementing the present invention or may be taught these concepts along with the lesson program. The proceeding two steps are taught to the reader as the “LOOK” steps, as illustrated in FIG. 1.

The reader now moves on to the “THINK” stage of the method. The reader learns to identify both the number of vowel graphemes in the individual word and the relationship of the vowel graphemes to one and other in the individual word. (Labeled 3 in FIG. 1) At this step, the reader is classifying the individual word based on whether the individual word has one vowel grapheme (4 in FIG. 1), two adjacent vowel graphemes (5 in FIG. 1), or two non-adjacent vowel graphemes (6 in FIG. 1). The reader is then taught to review the individual word to isolate the first voweletic unit in the word by determining the correct voweletic unit based upon voweletic placement in relation to another vowel or consonant(s) in the word. (41 FIG. 1)

A voweletic unit (listed as “VU” in the supporting FIGS.) is defined to be at least one vowel and its relationship with either at least one adjacent consonant following the one vowel and or at least one other vowel to determine at least one vowel phoneme. A vowel phoneme is defined as the smallest significant unit of sound, and further denoted herein by angled backslashes. To determine a voweletic unit within a word, the reader is taught to begin at the first vowel in the word. When a word has two or more vowels, the reader is taught to proceed to and include the next vowel within the voweletic unit. When the word has only one vowel, the reader is taught to proceed to and include the consonant(s) following the vowel. It has been found through testing that this method assists in establishing the highest probability in determining correct vowel sound. The reader is then taught to choose the appropriate voweletic unit and its assigned (or associated) vowel sound which may be short, long or special. A special vowel sound is defined as a vowel phoneme pronounced with neither a short or long vowel sound.

To assign either a short, long or special vowel sound to the first voweletic unit the reader must be taught to apply the following set of rules to the first vowel in the individual word. (FIG. 1, “What to do #1—4; What to do #2—5; and What Now?—6) If the individual word has one vowel and the number of vowels in the word equals one and the vowel is followed by at least one consonant, and the consonant is not the grapheme <r>, the short vowel sound is assigned. (VU¹, FIG. 1, 7) The word hem is an example of a word having a voweletic unit composed of one vowel with one consonant following the vowel and the consonant is not the grapheme <r>. The voweletic unit in the word “hem” would be assigned the short vowel sound. (FIG. 3, Voweletic Unit #1) It should be noted that in multi-syllable words, the first vowel in each syllable should be used first to determine the voweletic unit. The process can be then be reapplied to the next syllable. “Season” is an example of an English word having two voweletic unit wherein the first voweletic unit is the graphemes <ea> whereas the second voweletic unit is the graphemes <on>. (FIG. 3, Example #1) It should also be noted that the second vowel in a voweletic unit is often used again as the first vowel in the subsequent voweletic unit. For example, in the word “follow” the first voweletic unit is the graphemes <ollo> whereas the second voweletic unit is the graphemes <ow>. (FIG. 3, Example #2)

If, however, the number of vowels in the individual word equals one and the vowel is positioned at the end of said word, the long vowel sound is assigned. (VU², FIG. 1, 8) By example, the voweletic unit in the word “he” would is assigned the long vowel sound. (FIG. 3, Voweletic Unit #2)

If, however, the number of vowels in the individual word equals one and the number of vowels in said word equal one and said vowel is followed by the grapheme <r>, the special vowel sound is to be assigned. (VU³, FIG. 1, 9) By example, the voweletic unit in the word “her” would be assigned the special vowel sound. (FIG. 3, Voweletic Unit #3) As will be discussed further herein, the special sound is selected from a group of guide words sharing the special vowel sound and having graphemes consisting of <ar>, <or>, <er>, <ir>, or <ur>. (FIG. 1, 25-29)

If, however, the individual word has a first and second vowel which are adjacent, the special vowel sound will be selected, if the voweletic unit is found in the group of graphemes consisting of <oi>, <oy>, <aw>, <au>, <oo>, <ew>, <ow>or <ou>. (VU⁴, FIG. 1, 10) By example, the voweletic unit in the word “soil” would be assigned the special vowel sound. (FIG. 3, Voweletic Unit #4)

If, however, the individual word has a first and second vowel which are adjacent, and the voweletic unit is not found in the group of graphemes for the special vowel sound, the long vowel sound should be assigned to the voweletic unit. The long vowel sound is selected from the group of graphemes consisting of <ai>, <ay>, <ea>, <ee>, <ie>, <ow>, <oa>, <oe>, <ui>, or <ue>. (VU⁵, FIG. 1, 11) The forementioned long vowel combinations represent a group of graphemes which most commonly spell the long vowel sounds. By example, the voweletic unit in the word “sail” would be assigned the long vowel sound. (FIG. 3, Voweletic Unit #5)

If, however, the individual word has a first and second vowel, which are non-adjacent, the reader is taught to first count the number of the consonants in between the non-adjacent first and second vowels. (FIG. 1, 6) If the number of consonants between the two non-adjacent vowels equals one, the long vowel sound is to be assigned to the first vowel. (VU⁶, FIG. 1, 12) By example, the voweletic unit in the word “taping” would be assigned the long vowel sound. (FIG. 3, Voweletic Unit #6)

If, however, the individual word has a first and second vowel, which are non-adjacent and the number of consonants between the two non-adjacent vowels is greater than one, the short vowel sound is to be assigned to the first vowel. (VU⁶, FIG. 1, 13) By example, the first vowel in the voweletic unit in the word “tapping” would be assigned the short vowel sound. (FIG. 3, Voweletic Unit #7)

The process of determining what type of sound is to be assigned to the voweletic unit then allows the reader to select the corresponding guide word. (FIG. 1, 40) A guide word associates an appropriate vowel phoneme with the voweletic unit. A vowel phoneme is defined as the smallest significant unit of sound, and further denoted herein by angled backslashes. The vowel grapheme(s) of the guide word correspond to the vowel grapheme(s) of the voweletic unit and assist in the determination of the vowel phoneme to be assigned. By example, the guide word for “tapping” to determine the correct vowel phoneme is “Antly.” (FIG. 1, 15) The reader is taught and hears the guide word for the short vowel sound. The reader may then insert the determined vowel phoneme into the individual word to read the individual from the beginning of the individual word. (FIG. 1, 42) The guide words are selected to be easy to understand and relate to so they may be taught to the reader rather quickly. The following guide words have been generated for each respective vowel sound, as follows:

1. Short

| | | |
|---|---|---|
| short a | GUIDE WORD: Antly | 15 |
| short e | GUIDE WORD: Eggly | 16 |
| short i | GUIDE WORD: Iggly | 17 |
| short o | GUIDE WORD: Oxly | 18 |
| short u | GUIDE WORD: Uggly | 19 |

2. Long

| | | |
|---|---|---|
| long a | GUIDE WORD: Mr. A | 20 |
| long e | GUIDE WORD: Mr. E | 21 |
| long i | GUIDE WORD: Mr. I | 22 |
| long o | GUIDE WORD: Mrs. O | 23 |
| long u | GUIDE WORD: Mrs. U | 24 |

3. Special: Those that Make Neither a Short nor Long Vowel Sound

| | | |
|---|---|---|
| ar | GUIDE WORD: shark | 25 |
| or | GUIDE WORD: horn | 26 |
| er | GUIDE WORD: Fern | 27 |
| ir | GUIDE WORD: stir | 28 |
| ur | GUIDE WORD: burn | 29 |
| oi | GUIDE WORD: spoil | 30 |
| oy | GUIDE WORD: toy | 31 |
| aw | GUIDE WORD: hawk | 32 |
| au | GUIDE WORD: taught | 33 |
| ow | GUIDE WORD: cow (or) | 34 |
| | mow | 35 |
| ou | GUIDE WORD: out | 36 |
| oo | GUIDE WORD: boo | 37 |
| | book | 38 |
| ew | GUIDE WORD: new | 39 |

Those of ordinary skill in the art will appreciate that although the applicant claims the exclusive right use to such guide words in combination with the methods and apparatus disclosed and claimed herein, applicant's invention is not limited to the guide words listed above and any other equivalent words, similar in structure and function, may be used as guide words as recited in the claims.

For illustration of the method disclosed, FIG. 2 presents the word “SMART” for decoding 1. The vowel in SMART is <a> 2. There is one vowel grapheme <a> and it is followed by the letter <r>. According to FIG. 2 What to Do #1 applies (4). Next, the reader must determine the correct voweletic unit based on the vowel placement in relation to another vowel or consonant(s) in the word (41). Because there is an <r> after the <a>, the rules determine that the special vowel sound applies, as illustrated by the color of the chart. Then using the corresponding guide word that applies, the reader learns that the <ar> in the decoded word should be pronounced like the <ar> in the guide word “shark”. Inserting the <ar> sound taught by the guide word for the voweletic unit <ar> in the decoded word then produces the correct sound (pronunciation) when the word is read. (FIG. 1, 42) It should be noted that method of teaching claimed herein is further enhanced by the grid structure and arrangement illustrated in FIGS. 1-7. Readers can visually see the THINK system by using the grid-like structure and arrangement of the questions, rules and guide words of the Voweletics™ system.

As stated in the background information, the English language is difficult to learn, primarily due to the multiple vowel phonemes spelled with just a few vowel graphemes. As claimed and disclosed herein, the Voweletics method may be organized into a single chart 75 composed of three grids, one for each of the three classifications of vowels and affixed to a single sheet of paper. (FIGS. 1 & 2, 75) This pictorial representation serves as a memory prompter for the reader. It is unique in its ability to take the instruction from a complete reading system, reduce this information into grid-like graphic organizers, and create a predictable decoding system to aid the reader in determining correct vowel phonemes. A part of the uniqueness of the chart 75 is the ability to transfer this information easily from one medium to another and from educator to educator for a consistent teaching method.

FIGS. 1 and 2 illustrate another feature of the present invention—color. It is applicant's intent to use one color for each sound throughout all of the materials supporting the method. See FIG. 1-8, 11-15, 17. In FIG. 1 for example, green has been assigned to the voweletic units to be assigned the “short” sound (7, 13); correspondingly, the short sound guide words are also listed in the same color green (15-19). Orange has been assigned to the voweletic units to be assigned the “long” sound (8, 11 and 12); correspondingly, the long sound guide words are also listed in the same color orange (20-24, 35). Pink has been assigned to the voweletic units to be assigned the “special” sound (9-10); correspondingly, the special sound guide words are also listed in the same color pink (25-34, 36). Using this manipulative, the internal thinking process to categorize vowels according to their vowel patterns is forced upon the student thereby improving reader recall, stimulating right and left brain development while adding to the multi-sensory appeal of the present invention.

To teach the guide words to the reader, and further engage the reader in the learning process, applicant has created a character for each guide word selected from the group consisting of Antly, Eggly, Iggly, Oxly, and Uggly. (See FIGS. 4) As previously discussed, the preceding guide words can be presented in the unique color assigned to the “short” sound which in this case is green, thereby improving consistency and improving lesson retention. To further improve retention and engagement, the characters may have anthropomorphic characteristics i.e. the attribution of uniquely human characteristics and qualities to nonhuman beings and inanimate objects. For example, Antly is an ant that believes life will be good when you have a good attitude. These values of having a good attitude are exemplified throughout the reading context in the form of poems, worksheets, and phonetic readers. Bestowing human characteristics on the guide words allows for the guide words to have both added entertainment value and teaching qualities. For example, guide word characters can teach important social lessons including the value of a good attitude; strategies to reduce feelings of anxiety; the importance of being non-judgmental; the qualities of friendship; showing kindness and empathy towards others and or combinations of these qualities. This improves retention, re-inforces learning and gives important context to word meanings. Furthermore, the color coding, character attributes, stories and social lessons provide an opportunity to teach the present method across medias and in different contexts.

FIGS. 4-7 illustrate application of the present invention upon an article of manufacture, such as a bookmark and or printed sheet 49 wherein the materials are color coded according to the three vowel sound classifications (short, long and special). Additionally, character attributes, both aural and pictorial, have been added to the guide words. This manipulative stimulates the internal thinking process and re-inforces the categorization of the vowels according to their vowel patterns by the reader throughout the different media used to teach the method. FIG. 4 illustrates an example bookmark, illustrating the guide words and guide word characters for the What To Do #1 (FIG. 1, 4) wherein the following characters have been generated for each respective vowel sound, each respective guide word and each respective voweletic unit:

1. Short

| | | | |
|---|---|---|---|
| short a | GUIDE WORD: Antly | 15 | Character 50 |
| short e | GUIDE WORD: Eggly | 16 | Character 51 |
| short i | GUIDE WORD: Iggly | 17 | Character 52 |
| short o | GUIDE WORD: Oxly | 18 | Character 53 |
| short u | GUIDE WORD: Uggly | 19 | Character 54 |

2. Long

| | | | |
|---|---|---|---|
| long a | GUIDE WORD: Mr. A | 20 | Character 55 |
| long e | GUIDE WORD: Mr. E | 21 | Character 56 |
| long i | GUIDE WORD: Mr. I | 22 | Character 57 |
| long o | GUIDE WORD: Mrs. O | 23 | Character 58 |
| long u | GUIDE WORD: Mrs. U | 24 | Character 59 |

3. Special: (Those that Make Neither a Short nor Long Vowel Sound)

| | | | |
|---|---|---|---|
| ar | GUIDE WORD: shark | 25 | Character 60 |
| or | GUIDE WORD: horn | 26 | Character 61 |
| er | GUIDE WORD: Fern | 27 | Character 62 |
| ir | GUIDE WORD: stir | 28 | Character 63 |
| ur | GUIDE WORD: burn | 29 | Character 64 |

In FIG. 5 is another example of the application of the present invention upon an article of manufacture, such as a bookmark and or printed sheet 49 illustrating use of consistent color coding of the materials according to the three vowel sound classifications (short, long and special).

FIG. 6 also illustrates an example bookmark or printed sheet, illustrating guide words combined further combined with characters in situations for the What To Do #2 (FIG. 1, 5) wherein the following form a voweletic unit. The guide words link together the story to link similar vowel sounds or vowel spellings.

| | | | |
|---|---|---|---|
| oi | GUIDE WORD: spoil | 30 | SITUATION 66 |
| oy | GUIDE WORD: toy | 31 | SITUATION 66 |
| aw | GUIDE WORD: hawk | 32 | SITUATION 67 |
| au | GUIDE WORD: taught | 33 | SITUATION 67 |
| ow | GUIDE WORD: cow | 34 | SITUATION 68 |
| ow | GUIDE WORD: mow | 35 | SITUATION 68 |
| ou | GUIDE WORD: out | 36 | SITUATION 68 |
| oo | GUIDE WORD: book | 38 | SITUATION 69 |
| ew | GUIDE WORD: new | 39 | SITUATION 69 |

The guide words for this particular group of special vowel sounds were carefully chosen to maximize learning. Each set of guide words were grouped together because they either taught two vowel phonemes for one spelling and or two spellings for one vowel phoneme. The chosen guide words create a situation or a story presented in the lyrics of their associated teaching songs. The song titles listed below suggest the situation or story from the songs that link the guide words together for easy memorization:
Situation 66: “Don't Spoil the Toy”—spoil 30 and toy 31
Situation 67: “The Hawk that Taught”—hawk 32 and taught 33
Situation 68: “Cow Out to Mow”—cow 34, out 36 and mow 35
Situation 69: “Boo, hoo! I'd Like a New Book”—boo 37, new 39 and book 38

As discussed, the guide words spoil 30 and toy 31; hawk 32 and taught 33; and Fern 27, stir 28 and burn 29, in addition to be using in songs and music, may be transferred to other media for presentation including flashcards, lessons, and charts or combinations therein to teach one vowel phoneme with multiple spellings.

Furthermore, the guide words cow 34, out 36, and mow 35; and book 38, boo 37, and new 39 in addition to be using in songs and music, may also be transferred to other media for presentation including flashcards, lessons, and charts or combinations therein to teach one vowel phoneme with multiple spellings or a plurality of vowel phonemes with one spelling.

The preceding FIGS. 4-7 also illustrate that the article of manufacture may have another embodiment of applicant's method and apparatus which applicant has defined as a vowel finder 65. A vowel finder 65 is a transparent portion article having an opaque or darkened line placed upon it. The vowel finder may be combined with a bookmark or printed sheet 49 as shown, if the vowel finder portion of the body is clear or transparent. The vowel finder 65 may be produced as a stand alone design (not in combination with a book mark) to promote and facilitate easy identification of vowels found in words. The vowel finder 65 may be comprised of a rectangle made of clear plastic. (Not shown) Typically it has a thin blue or black line to help students locate vowels in words. The vowel finder 65 should be sized to allow readers to slide the vowel finder from vowel to vowel on a written page or a computer screen. The reader may also use it to count the consonants between the vowels to help determine the correct vowel phoneme. The areas adjacent the opaque line on the vowel finder should be clear so that students may see the entire word which promotes correct word processing; yet allow breakdown of the word into smaller parts or syllables to aid the process of correct vowel phoneme determination. Vowel finders work in a similar manner when students are tracking words and not just vowels. The clear or transparent body or portion of the vowel finder will help a student keep their place without covering valuable written context used in processing a passage, resulting in improved reading comprehension. The vowel finder 65, as shown in FIGS. 4-7 also serves as a visual reminder for students to apply the phonetic tools presented in the Voweletics™ program.

FIG. 7 is also another example of the application of the present invention upon an article of manufacture, such as a bookmark and or printed sheet 49 illustrating use of consistent color coding of the materials according to the three vowel sound classifications (short, long and special) in combination with the guide words to be used for each vowel sound classification. See also FIG. 8 which is an example of a color coded printed sheet 49 incorporating a review lesson for voweletic units 7-9 and 10-11 wherein the words allow the reader to drill on the appropriate sounds (short, long, special) to be applied to the words under the rules of the method. FIG. 9 illustrates an example embodiment wherein the rules may still be applied and drilled without color and connect spelling to the phonetic rules.

It is also within the scope of this invention that the Voweletics™ method be embodied in music and songs to teach and reinforce learning of the reading method. FIG. 10 is an illustrative lesson plan wherein music and songs are to be incorporated in the learning and re-inforcement of the method. As designed, increased repetition is possible because the music includes stories about the characters associated with the guide words. Songs and music also stimulate multi-sensory learning leading to right and left brain engagement thus improved learning and retention result. FIG. 10 illustrates an example lesson plan 70 incorporating music and songs. An original 21-track CD is used throughout the program. The songs were created to provide a memorable, engaging component to help in the memorization of Voweletics™ principles. Short instruction is given on the CD at the start of each song. This instruction prompts students as to the teaching the lesson plan song provides. A songbook may also be contained within the Voweletics™ workbook, as illustrated by the example songs 71 found at FIG. 11 and FIG. 17. The songs 71 teach either a vowel rule or identification of a particular vowel phoneme and its associated spellings. The songbook may include the lyrics 72, drawings of guide word characters 73, and full or partial THINK System grids 75 (Not shown). Although not limiting, each song is typically introduced as it coincides with the new vowel sounds and rules presented in the session. FIGS. 12-13 illustrate how persuasive and re-inforcing the present invention may be.

FIG. 12 is another article of manufacture, such as a flash card for the vowel phonemes (sounds) spelled with <oo>, <ew> which connects its assigned sound to its assigned character. To further re-inforce the learning, the flash card is in the appropriate assigned color (pink) which illustrates that it is subject to the “special” vowel sound. The words and the character shown in FIGS. 12A and 12B were the subject of the example song 71 illustrated in FIG. 11 “Boo, hoo! I'd like a new book” (FIG. 11). The corresponding guide words boo 37, new 39, and book 38 express the vowel phonemes for <oo> and <ew> are easily remembered through the use of song, story and flash cards.

Finally, to test comprehension and drill the material for the reader, FIG. 13 includes an example of a color coded printed sheet 49 incorporating a review lesson for determining what rules to apply to the voweletic units 10, 11 (special) wherein the words tested support the learning in the flash cards 49 and allow the reader to drill on the appropriate special vowel sounds to be applied to the words under the rules of the method. It should be noted that the visual images 73 associated with the word are also consistent throughout the materials.

FIG. 14 illustrates another example of an integrative tool that may be used with the present method. The vowel based method of learning the reading of English according to the present invention may be improved further by multi-sensory stimulation exercises which induce right and left brain learning to increase the range of applicable student styles to which the method may be applied. It has been found that an excellent way to stimulate this type of learning is through the use of a color coded phonetic reader 74 that includes stories with the guide word characters. The character attributes remain constant throughout the readers. Students are better able to read more complex text when the carefully chosen vocabulary follows the phonetic rule patterns taught in the Voweletics™ reading program. The color coding lines below the vowel phonemes in the phonetic readers is consistent with the rules for short, long and special. They serve as an aid to the reader when encountering unfamiliar words prompting the reader to use the decoding skills taught in the program. This type of learning device encourages transfer from the newly acquired decoding skills in isolation to application in context. FIG. 15 illustrates another example of an integrative tool that may be used with the present method through a written poem. Again, the poems encourage transfer of the newly acquiried decoding skills in isolation to application in context. They re-inforce and teach vowel sounds in their words.

Although not shown in the accompanying figures, those of ordinary skill in the arts will appreciate that the present invention may be implemented in software in which the elements of the present invention are essentially the code segments to perform the necessary tasks. The program or code segments can be stored in a processor readable medium or transmitted by a computer data signal embodied in a carrier wave, or a signal modulated by a carrier, over a transmission medium. The “processor readable medium” may include any medium that can store or transfer information. Examples of the processor readable medium include an electronic circuit, a semiconductor memory device, a ROM, a flash memory, an erasable ROM (EROM), a floppy diskette, a compact disk CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc.

Furthermore, as illustrated in FIG. 16, a computer system may be adapted to use the present invention. Computer system 500 may implement any portion or embodiment of the present invention. Computer system 500 may implement tutorials via appropriate executable instructions stored in non-volatile memory. Alternatively, computer system 500 may create computer readable indicia via appropriate executable instructions stored in non-volatile memory. As shown in FIG. 16, central processing unit (CPU) 501 is coupled to system bus 502. The CPU 501 may be any general purpose CPU such as an Intel Pentium processor. However, the present invention is not restricted by the architecture of CPU 501 as long as CPU 501 supports the inventive operations as described herein. Bus 502 is coupled to random access memory (RAM) 503, which may be SRAM, DRAM, or SDRAM. ROM 504 is also coupled to bus 502, which may be PROM, EPROM, or EEPROM. RAM 503 and ROM 504 hold user and system data and programs as is well known in the art. Bus 502 is also coupled to input/output (I/O) controller card 505, communications adapter card 511, user interface card 508, and display card 509. The I/O card 505 connects to storage devices 506, such as one or more of hard drive, CD drive, floppy disk drive, tape drive, to the computer system. Communications card 511 is adapted to couple the computer system 500 to a network 512, which may be one or more of telephone network, local (LAN) and/or wide-area (WAN) network, Ethernet network, and/or Internet network. User interface card 508 couples user input devices, such as keyboard 513 and pointing device 507, to the computer system 500. The display card 509 is driven by CPU 501 to control the display on display device 510. System 500 further comprises color printer 514 that may be utilized to print computer readable indicia. System 500 further comprises optical scanner 515 which may be utilized to digitize computer readable indicia.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A vowel based method of learning the reading of English comprising:
a. Identifying an individual word composed of at least vowel and at least one consonant;
b. Identifying a first vowel grapheme occurring in said individual word wherein a grapheme is defined as a basic unit of writing language, further denoted herein by brackets, and selected from the group consisting of <a>, <e>, <i>, <o>, <u>, <y> or <w>;
c. Identifying if a second vowel grapheme exists in said individual word;
d. Classifying said individual word based on whether said individual word has one vowel grapheme, two adjacent vowel graphemes, or two non-adjacent vowel graphemes;
e. Reviewing said individual word to isolate at least one voweletic unit wherein said at least one voweletic unit is defined by at least one vowel and its relationship with either at least one adjacent consonant following said at least one vowel and or at least one other vowel to determine at least one vowel phoneme wherein said at least one vowel phoneme is defined as the smallest significant unit of sound, and further denoted herein by angled backslashes;
f. Assigning either a short, long or special vowel sound to said at least one voweletic unit, wherein said special vowel sound is defined as a vowel phoneme pronounced with neither a short or long vowel sound, by applying a set of rules to said at least one voweletic unit further comprising:
i. If said individual word has one vowel:
1. and the number of vowels in said word equal one and said vowel is followed by at least one consonant, and said consonant is not the grapheme <r>, the short vowel sound is assigned; or,
2. and the number of vowels in said word equal one and said vowel is positioned at the end of said word, the long vowel sound is assigned; or,
3. and the number of vowels in said word equal one and said vowel is followed by the grapheme <r>, the special sound is assigned;
ii. If said individual word has a first and second vowel which are adjacent:
1. the special vowel sound is selected from the group of graphemes consisting of <oi>, <oy>, <aw>, <au>, <oo>, <ew>, <ow> or <ou>; or,
2. the long vowel is selected from the group of graphemes consisting of <ai>, <ay>, <ea>, <ee>, <ie>, <ow>, <oa>, <oe>, <ui>, or <ue>;
iii. If said individual word has a first and second vowel, which are non-adjacent:
1. and the number of consonants between said two non-adjacent vowels equals one, the long vowel sound may be assigned to said first vowel; or,
2. and the number of consonants between said two non-adjacent vowels is greater than one, the short vowel sound may be assigned to said first vowel; and,
g. Selecting a guide word from a list of short, long or special guide words dependant on whether the short, long or special vowel sound was assigned to the voweletic unit wherein the vowel grapheme(s) of said guide word corresponds to the vowel grapheme(s) of said voweletic unit to determine the vowel phoneme to be assigned; and,
h. Inserting said determined vowel phoneme into said individual word to read said individual from the beginning of said individual word.

2. The vowel based method of learning the reading of English according to claim 1 wherein said short vowel sound is to be assigned to said at least one voweletic unit of said individual word, and wherein the first vowel grapheme of said voweletic unit corresponds to the first vowel grapheme of a guide word, said guide word associating the appropriate vowel phoneme for said at least one voweletic unit.

3. The vowel based method of learning the reading of English according to claim 2 wherein said guide word is selected from the group consisting of Antly, Eggly, Iggly, Oxly, and Uggly.

4. The vowel based method of learning the reading of English according to claim 3 wherein said guide words correspond with a character having anthropomorphic characteristics for improved retention.

5. The vowel based method of learning the reading of English according to claim 4 wherein said characters having anthropomorphic characteristics teach social lessons.

6. The vowel based method of learning the reading of English according to claim 5 wherein said characters having anthropomorphic characteristics teach social lessons selected from the group consisting of the value of a good attitude, strategies to reduce feelings of anxiety, the importance of being non-judgmental, the qualities of friendship, showing kindness and empathy towards others and or combinations therein.

7. The vowel based method of learning the reading of English according to claim 1 wherein the said long vowel sound is to be assigned to said at least one voweletic unit of said individual word, and wherein the first vowel grapheme of said voweletic unit corresponds to the first vowel grapheme of a guide word, said guide word associating the appropriate vowel phoneme for said at least one voweletic unit.

8. The vowel based method of learning the reading of English according to claim 7 wherein said guide word is selected from the group consisting of Mr. A, Mr. E, Mr. I, Mrs. O and Mrs. U.

9. The vowel based method of learning the reading of English according to claim 8 wherein said guide words correspond with a character having anthropomorphic characteristics for improved retention.

10. The vowel based method of learning the reading of English according to claim 1 wherein said individual word has a first and second vowel which are adjacent and said special vowel sound is to be assigned to said at least one voweletic unit of said individual word, a guide word associating the appropriate vowel phoneme for said at least one voweletic unit is selected from a group of guide words having graphemes consisting of <oi>, <oy>, <aw>, <au>, <oo>, <ew>, <ow> or <ou>.

11. The vowel based method of learning the reading of English according to claim 10 wherein said guide word is selected from the group consisting of spoil, toy, hawk, taught, boo, new, book, cow and out.

12. The vowel based method of learning the reading of English according to claim 11 wherein said guide words correspond with a character having anthropomorphic characteristics for improved retention.

13. The vowel based method of learning the reading of English according to claim 1 wherein the special sound is to be assigned to said voweletic unit and the number of said vowels in said individual word equals one and said vowel is followed by the grapheme <r>, a guide word associating the appropriate vowel phoneme for said at least one voweletic unit is selected from a group of guide words having graphemes consisting of <ar>, <or>, <er>, <ir>, or <ur>.

14. The vowel based method of learning the reading of English according to claim 13 wherein said guide word is selected from the group consisting of shark, horn, Fern, stir, and burn.

15. The vowel based method of learning the reading of English according to claim 14 wherein said guide words correspond with a character having anthropomorphic characteristics for improved retention.

16. The vowel based method of learning the reading of English according to claim 1 wherein said method is set to music.

17. The vowel based method of learning the reading of English according to claim 1 wherein said method is accompanied by music and songs to teach said vowel graphemes, said vowel phonemes and said voweletic units.

18. The vowel based method of learning the reading of English according to claim 1 wherein said short, long and special vowel sounds are each assigned a unique color, said unique color to be applied consistently throughout said method.

19. The vowel based method of learning the reading of English according to claim 18 in combination with a phonetic reader wherein said unique color is applied consistently throughout said phonetic reader according to the steps of the method.

20. The vowel based method of learning the reading of English according to claim 1 wherein said method is downloadable from an internet website.

21. The vowel based method of learning the reading of English according to claim 1 wherein said method is stored on a recordable medium selected from the group consisting of tapes, CD-Roms, digital video discs, and or combinations therein.

22. The vowel based method of learning the reading of English according to claim 1 wherein a vowel finder is used to isolate said at least one vowel grapheme on a page to enable implementation of the reading methodology wherein said vowel finder further comprises:
a. a transparent body, said transparent body sized to allow isolation of at least one individual word on a page;
b. a non-transparent line, said non-transparent line intersecting said transparent body of said vowel finder wherein a user of said vowel finder may slide the vowel finder from vowel to vowel to assist said user with isolation of said vowels within said individual word on said page while not obscuring the non-isolated portions of said individual word.

23. The vowel based method of learning the reading of English according to claim 22 wherein said vowel finder is used to guide said user around said page.

24. The vowel based method of learning the reading of English according to claim 1 wherein said method includes multi-sensory stimulation exercises selected from the group consisting of songs, games, visual clues, color coding and combinations therein to enhance learning.

25. The vowel based method of learning the reading of English according to claim 1 wherein said method is organized into a plurality of grids, said grids providing a visual clue as to the organization and application of the rules of said method.

26. A vowel based method of teaching the reading of English to increase the probability of expressing the correct vowel phoneme comprising:
c. Teaching a student to identify a vowel grapheme wherein said vowel grapheme is defined as a basic unit of written English, and further denoted herein by brackets, and selected from the group consisting of <a>, <e>, <i>, <o>, <u>, <y> or <w>;
d. Teaching said student a set of guide words, wherein each said guide word corresponds to each said vowel grapheme and wherein said guide word associates with an appropriate vowel phoneme wherein said vowel phoneme is defined as the smallest significant unit of sound, and further denoted herein by angled backslashes;
e. Teaching said student to identify a voweletic unit wherein said at least one voweletic unit is defined by at least one vowel and its relationship with either at least one adjacent consonant following said at least one vowel and or at least one other vowel to determine at least one vowel phoneme wherein said at least one vowel phoneme is defined as the smallest significant unit of sound, and further denoted herein by angled backslashes;
f. Teaching said student to identify a voweletic unit pattern further comprising:
i. Teaching classification of said at least one vowel phoneme occurring in said individual word based on whether said voweletic unit has one vowel, two adjacent vowels, or two non-adjacent vowels;
ii. Teaching assignment of either a short, long or special vowel sound to said at least one voweletic unit, wherein said special vowel sound is defined as a vowel phoneme pronounced with neither a short or long vowel sound, by applying a set of rules to said at least one voweletic unit further comprising:
1. If said individual word has one vowel:
a. and the number of vowels in said word equal one and said vowel is followed by at least one consonant, and said consonant is not the grapheme <r> wherein a grapheme is defined as a basic unit of writing language, the short vowel sound is assigned; or,
b. and the number of vowels in said word equal one and said vowel is positioned at the end of said word, the long vowel sound is assigned; or,
c. and the number of vowels in said word equal one and said vowel is followed by the grapheme <r>, the special sound is assigned;
2. If said individual word has a first and second vowel which are adjacent:
a. the special vowel sound is selected from the group of graphemes consisting of <oi>, <oy>, <aw>, <au>, <oo>, <ew>, <ow> or <ou>; or,
b. the long vowel is selected from the group of graphemes consisting of <ai>, <ay>, <ea>, <ee>, <ie>, <ow>, <oa>, <oe>, <ui>, or <ue>;
3. If said individual word has a first and second vowel, which are non-adjacent:
a. and the number of consonants between said two non-adjacent vowels equals one, the long vowel sound may be assigned to said first vowel; or,
b. and the number of consonants between said two non-adjacent vowels is greater than one, the short vowel sound may be assigned to said first vowel; and,
g. Teaching said student to assign said at least one vowel phoneme to one of seven said voweletic units based on said voweletic pattern; and,
h. Having said student read said individual word from the beginning of said individual word inserting the correctly determined vowel phoneme.

27. The vowel based method of teaching the reading of English to increase the probability of expressing the correct vowel phoneme according to claim 26 wherein said short vowel sound is to be assigned to said at least one voweletic unit of said individual word, and wherein the vowel grapheme of said voweletic unit corresponds to the first vowel grapheme of a guide word, said guide word associating the appropriate vowel phoneme for said at least one voweletic unit.

28. The vowel based method of teaching the reading of English to increase the probability of expressing the correct vowel phoneme according to claim 27 wherein said guide word is selected from the group consisting of Antly, Eggly, Iggly, Oxly, and Uggly.

29. The vowel based method of teaching the reading of English to increase the probability of expressing the correct vowel phoneme according to claim 28 wherein said guide words correspond with a character having anthropomorphic characteristics for improved retention.

30. The vowel based method of teaching the reading of English to increase the probability of expressing the correct vowel phoneme according to claim 29 wherein said characters having anthropomorphic characteristics teach social lessons.

31. The vowel based method of teaching the reading English to increase the probability of expressing the correct vowel phoneme according to claim 30 wherein said characters having anthropomorphic characteristics teach social lessons selected from the group consisting of the value of a good attitude, strategies to reduce feelings of anxiety, the importance of being non-judgmental, the qualities of friendship, showing kindness and empathy towards others and or combinations therein.

32. The vowel based method of teaching the reading of English to increase the probability of expressing the correct vowel phoneme according to claim 26 wherein the said long vowel sound is to be assigned to said at least one voweletic unit of said individual word, and wherein the vowel grapheme of said voweletic unit corresponds to the first vowel grapheme of a guide word, said guide word associating the appropriate vowel phoneme for said at least one voweletic unit.

33. The vowel based method of teaching the reading of English to increase the probability of expressing the correct vowel phoneme according to claim 32 wherein said guide word is selected from the group consisting of Mr. A, Mr. E, Mr. I, Mrs. O and Mrs. U.

34. The vowel based method of teaching the reading of English to increase the probability of expressing the correct vowel phoneme according to claim 33 wherein said guide words correspond with a character having anthropomorphic characteristics for improved retention.

35. The vowel based method of teaching the reading of English to increase the probability of expressing the correct vowel phoneme according to claim 26 wherein said individual word has a first and second vowel which are adjacent and said special vowel sound is to be assigned to said at least one voweletic unit of said individual word, a guide word associating the appropriate vowel phoneme for said at least one voweletic unit is selected from a group of guide words having graphemes consisting of <oi>, <oy>, <aw>, <au>, <oo>, <ew>, <ow> or <ou>.

36. The vowel based method of teaching the reading of English to increase the probability of expressing the correct vowel phoneme according to claim 35 wherein said guide word is selected from the group consisting of spoil, toy, hawk, taught, boo, new, book, cow, mow and out.

37. The vowel based method of teaching the reading of English to increase the probability of expressing the correct vowel phoneme according to claim 36 wherein said guide words spoil and toy; hawk and taught; and Fern, stir and burn; are transferred to a media for presentation wherein said media is selected from the group consisting of songs, music, flashcards, lessons, and charts or combinations therein to teach one vowel phoneme with multiple spellings.

38. The vowel based method of teaching the reading of English to increase the probability of expressing the correct vowel phoneme according to claim 36 wherein said guide words cow, out, and mow; and book, boo, and new; are transferred to a media for presentation wherein said media is selected from the group consisting of songs, music, flashcards, lessons, and charts or combinations therein to teach one vowel phoneme with multiple spellings or a plurality of vowel phonemes with one spelling.

39. The vowel based method of teaching the reading of English to increase the probability of expressing the correct vowel phoneme according to claim 37 wherein said guide words correspond with a character having anthropomorphic characteristics for improved retention.

40. The vowel based method of teaching the reading of English to increase the probability of expressing the correct vowel phoneme according to claim 27 wherein the special sound is to be assigned to said voweletic unit and the number of said vowels in said individual word equals one and said vowel is followed by the grapheme <r>, a guide word associating the appropriate vowel phoneme for said at least one voweletic unit is selected from a group of guide words having graphemes consisting of <ar>, <or>, <er>, <ir>, or <ur>.

41. The vowel based method of teaching the reading of English to increase the probability of expressing the correct vowel phoneme according to claim 40 wherein said guide word is selected from the group consisting of shark, horn, Fern, stir, and burn.

42. The vowel based method of teaching the reading of English to increase the probability of expressing the correct vowel phoneme according to claim 41 wherein said guide words correspond with a character having anthropomorphic characteristics for improved retention.

43. The vowel based method of teaching the reading of English to increase the probability of expressing the correct vowel phoneme according to claim 42 wherein said method is accompanied by music and lyrical songs for association with a story to teach said vowel graphemes, said vowel phonemes and said voweletic units.

44. The vowel based method of teaching the reading of English to increase the probability of expressing the correct vowel phoneme according to claim 43 wherein said guide word and said guide word character having anthropomorphic characteristics are transferred to a media for presentation wherein said media is selected from the group consisting of songs, music, flashcards, lessons, and charts or combinations therein.

45. The vowel based method of teaching the reading of English to increase the probability of expressing the correct vowel phoneme according to claim 26 wherein said short, long and special vowel sounds are each assigned a unique color, said unique color to be applied consistently throughout said method.

46. The vowel based method of teaching the reading of English to increase the probability of expressing the correct vowel phoneme according to claim 45 wherein the color green is assigned to said short vowel sound; wherein the color orange is assigned to said long vowel sound; and wherein the color pink is assigned to said special vowel sound.

47. The vowel based method of teaching the reading of English to increase the probability of expressing the correct vowel phoneme according to claim 46 in combination with a phonetic reader wherein said unique color is applied consistently throughout said phonetic reader according to the steps of the method.

48. The vowel based method of teaching the reading of English to increase the probability of expressing the correct vowel phoneme according to claim 26 wherein said method is downloadable from an internet website.

49. The vowel based method of teaching the reading English to increase the probability of expressing the correct vowel phoneme according to claim 26 wherein said method is stored on a recordable medium selected from the group consisting of tapes, CD-Roms, digital video discs, and or combinations therein.

50. The vowel based method of teaching the reading English to increase the probability of expressing the correct vowel phoneme according to claim 26 wherein said method is implemented through a software program executable on a computer.

51. The vowel based method of teaching the reading of English to increase the probability of expressing the correct vowel phoneme according to claim 26 wherein said method is implemented in a computer-aided language tutorial.

52. The vowel based method of teaching the reading of English to increase the probability of expressing the correct vowel phoneme according to claim 51 wherein said computer-aided language tutorial is a foreign language tutorial.

53. A vowel based method of teaching the reading of English to increase the probability of expressing the correct vowel phoneme according to claim 26 further comprising creating a chart, said chart organized into a plurality of grids, said grids providing a visual clue as to the organization and application of the rules of said method.

54. A vowel finder to aid in isolating the various pictorial or visual elements found on a printed page comprising:
a. A transparent body; and,
b. A line bisecting said transparent body, wherein said transparent body may be placed over said individual word composed of at least one vowel and at least one consonant or at least one other vowel, said line of said transparent body used to visually isolate said at least one vowel from said at least one consonant or said at least one other vowel to promote identification of at least one voweletic unit.

55. The vowel finder according to claim 54 wherein said vowel finder is combined with other learning aids selected from the group consisting of vowel graphemes, guide words, guide word characters, vowel phonemes, voweletic units and or combinations thereof.

56. A vowel finder to aid in isolating the various pictorial or visual elements found on a printed page according to claim 54 wherein a user of said vowel finder may slide the vowel finder from vowel to vowel to assist said user with isolation of said vowels within said individual word on said printed page while not obscuring the non-isolated portions of said individual word.

57. A vowel finder to aid in isolating the various pictorial or visual elements found on a printed page according to claim 54 wherein said vowel finder is used to guide said user around said page.
